(19) United States
(12) Patent Application Publication
(10) Pub. No.: US 2014/0304654 A1
(43) Pub. Date: Oct. 9, 2014

(54) Wine Rating Tool, Simulator & Game For Portable Computing Device

(71) Applicant: The John Nicholas and Kristin Gross Trust U/A/D April 13, 2010, Berkeley, CA (US)

(72) Inventor: John Nicholas Gross, Berkeley, CA (US)

(21) Appl. No.: 14/183,036

(22) Filed: Feb. 18, 2014

Related U.S. Application Data
(63) Continuation-in-part of application No. 13/651,171, filed on Oct. 12, 2012, now Pat. No. 8,671,012.
Application No. 13/651,171 is a continuation-in-part of application No. 13/651,197, filed on Oct. 12, 2012, now Pat. No. 8,744,900.
Application No. 13/651,197 is a continuation-in-part of application No. 13/651,229, filed on Oct. 12, 2012.
Application No. 13/651,229 is a continuation-in-part of application No. 13/651,254, filed on Oct. 12, 2012, now Pat. No. 8,756,097.
Application No. 13/651,254 is a continuation-in-part of application No. 13/651,267, filed on Oct. 12, 2012.
Application No. 12/335,247 is a continuation-in-part of application No. 13/974,852, filed on Aug. 23, 2013.
Application No. 13/974,852 is a continuation of application No. 13/651,279, filed on Oct. 12, 2012, now Pat. No. 8,521,580.
Application No. 13/651,279 is a continuation of application No. 12/335,247, filed on Dec. 15, 2008, now Pat. No. 8,321,261.
(60) Provisional application No. 61/013,943, filed on Dec. 14, 2007.
(60) Provisional application No. 61/020,484, filed on Jan. 11, 2008.
(60) Provisional application No. 61/043,363, filed on Apr. 8, 2008.

(51) Int. Cl. G06F 3/0482; G06F 3/0484

(52) U.S. Cl. CPC G06F 3/0482; G06F 3/04842
USPC 715/811

(57) ABSTRACT

Items—including gourmet products—are evaluated and rated by participants in a controlled event, with an interface adapted to capture numerical ratings and other descriptors. Events can be facilitated and simulated by a game wizard to assist in planning and effecting events.

### CROSS-REFERENCE TO RELATED APPLICATIONS

The present application claims priority to and is a continuation-in-part of the following:

(1) U.S. application Ser. No. 13/651,171, filed Oct. 12, 2012, docket JNG 2008-10DIV1;

(2) U.S. application Ser. No. 13/651,197, filed Oct. 12, 2012, docket JNG 2008-10DIV2;

(3) U.S. application Ser. No. 13/651,229, filed Oct. 12, 2012, docket JNG 2008-10DIV3;

(4) U.S. application Ser. No. 13/651,254, filed Oct. 12, 2012, docket JNG 2008-10DIV5; and

(5) U.S. application Ser. No. 13/651,267, filed Oct. 12, 2012, docket JNG 2008-10DIV6.

All of those applications are divisionals of U.S. patent application Ser. No. 12/335,247, filed Dec. 15, 2008, now U.S. Pat. No. 8,321,261.

This application claims priority to and is also a continuation-in-part of U.S. application Ser. No. 13/974,852, filed Aug. 23, 2013, docket JNG 2008-10C2C1, which is a continuation of U.S. application Ser. No. 13/651,279, filed Oct. 12, 2012, now U.S. Pat. No. 8,521,580, which is a continuation of U.S. patent application Ser. No. 12/335,247, filed Dec. 15, 2008, now U.S. Pat. No. 8,321,261.

U.S. application Ser. No. 12/335,247, in turn, claims the benefit under 35 U.S.C. 119(e) of the priority date of the following: Provisional Application Ser. Nos. 61/013,943 filed Dec. 14, 2007; 61/020,484 filed Jan. 11, 2008; and 61/043,363 filed Apr. 8, 2008.

In addition, this application is related to U.S. application Ser. No. 13/193,847, filed Jul. 29, 2011, now U.S. Pat. No. 8,620,736, and to U.S. application Ser. No. 13/651,243, filed Oct. 12, 2012, now U.S. Pat. No. 8,626,608.

All of the above applications are incorporated by reference herein in their entireties.

### FIELD OF THE INVENTION

The present invention relates to social games, planning tools and graphical interface tools used for rating gourmet food/drink entertainment events.

### BACKGROUND

Wine tastings are popular events that are enjoyed both on a commercial and non-commercial basis. At the one extreme, various organizations are known to put on large scale events to rate vintages offered by different wine labels, and is sometimes these events are open to the public for their enjoyment as well. These festivals are extremely popular and attract large crowds interested in wines. Individual wineries also offer tastings of their products on a small scale for the benefit of visitors. These functions allow wineries to collect data directly from consumers on the likeability of different types of wine.

Finally, at the public level, so-called private “wine tasting parties” represent yet another form of entertainment and enjoyment that is popular at this time. At such functions, individuals are invited to taste, discuss and rate wines as part of the social activities. Such parties are becoming more commonplace, but the wineries and other vendors associated with such products have not been able to tap into the information exchanged at such events.

There are some Internet/e-commerce entities also dedicated to wine and related products. For example a website identified as www.winelog.net is dedicated to wine lovers and includes a tool for members to enter their wine ratings and receive recommendations. Winelog describes itself as an “online community of wine drinkers.” The limitation of this site is that it caters only to persons who have taken the time to find the site and have registered specifically as members. This tends to restrict the community to hard core oenophiles. Moreover it does not appear to coordinate and tie together the collected ratings data for wine growers, consumers and merchants of such products. Consequently the user population and popularity of such system does not appear to be significant.

In addition, techniques for rating wine are known in the art, including through ratings and descriptors, such as shown in U.S. Pat. No. 7,124,035 including color, appearance, aroma, bouquet, finish and so on incorporated by reference herein. Other techniques for classifying and rating winds such as shown in US Pub. No. 20130080438 and US Pub 20130339348 are also incorporated by reference herein.

Prior art techniques for collecting data for food/drink preferences have been rather limited. It would be preferable if there were some manner of increasing the participation rate in the general public to enhance knowledge of consumer preferences.

### SUMMARY OF THE INVENTION

An object of the present invention, therefore, is to overcome and/or reduce the aforementioned limitations of the prior art.

A first aspect of the invention concerns a method of conducting a sampling event for items comprising: (a) providing one or more electronic data collection devices; (b) collecting at least a set of ratings for the set of items from a group of participants using a first routine executing on the one or more electronic data collection devices during the item sampling event; (c) calculating item sampling event data including at least item scores and participant scores using a second computing routine; (d) providing at least some of the item sampling event data through a network to one or more electronic computing systems associated with third parties involved in the making, distributing and/or selling of the items; and (e) receiving promotional coupons and/or other electronic feedback from such third parties at the one or more electronic data collection devices or other is electronic message accounts associated with the group of participants. The promotional coupons and/or other electronic feedback are preferably coupled and dynamically adjustable based on a geographical location of the one or more data collection devices and/or a residence address of the group of participants.

In preferred embodiments the one or more electronic data collection devices include a single phone based computing device which is adapted to present a data capture interface which varies for multiple users. Additional steps such as (b)′: receiving prediction data from the participants concerning the expected ratings to be provided by other participants for one or more of the items; and/or receiving prediction data from the participants concerning the actual ratings provided by experts for one or more of the items can also be implemented.

The method further preferably includes a step: determining one or more participant winners based on an overall group participant rating provided to items submitted by such participants. Additional steps of computing a rating and participant correlation score can be done to determine at least one or more of the following:
a. which pair of participants provided the closest ratings results;
b. which pair of participants provided the most disparate ratings results;
c. which identified couple in the group provided the closest ratings data;
d. which identified couple in the group provided the most disparate ratings data;
e. a deviation from aggregate group scores on a participant by participant basis;
f. one or more participants who subjectively gave the lowest rating to the item rated highest by the group;
g. one or more participants who gave the highest rating to the item rated lowest by the group;
h. one or more participants who gave the lowest rating to the item rated lowest by the group;
i. one or more participants who gave the highest rating to the items rated highest by the group;
j. a score of each item broken down by sex or age groups.

In some embodiments the following additional steps can also be optionally included:

presenting advertising to the participants electronically through the one more electronic data collection devices during the sampling event, which advertising is related to the items and/or items correlated to the items can be done:

compiling ratings and other event data for one or more the participants and presenting the same to websites for which the participants have social networking memberships;

automatically identifying a nearest location for each of the participants on the one or more data collection devices for purchasing one or more of the items;

deriving the sampling data in part from kit data associated with a predetermined item sampling kit containing the set of items and associated identification information—the set of items can be packaged in a manner to obscure their identity and/or origin to the group of participants;

configuring the electronic data collection devices to communicate directly to a restaurant or bar computing system through a network;

configuring the electronic data collection devices to automatically capture identification information from the set of items—wherein the identification information includes one of: a barcode, an image, an alphanumeric label, and/or a radio frequency (RF) identification;

capturing the set of ratings with a speech recognition system;

predicting one or more items of interest to at least some of the participants based on a collaborative filtering and/or a corroborative filtering analysis;

monitoring redemptions of the participants of the promotional coupons.

determining which one or more of the participants provide(s) ratings best correlating to prior scores given by other participants in other sampling events;

presenting electronic dynamically to the participants during the event;

registering the item sampling event with a centralized computing system accessible at one more item vending establishments, and wherein the centralized computing system monitors and tracks purchases made by participants for the event to prevent duplication and provide recommendations to such participants;

coupling the one or more electronic data collection devices during the item sampling event to provide common updates to each such device; wherein one of the one or more electronic data collection devices is configured as a master for conducting the item sampling event and coordinating data collection from the other electronic data collection devices;

allowing the participants to be located at disparate geographic locations;

providing recommendations for different types of items;

presenting an output of results of the item sampling event to the participants in text or graphical form;

providing ongoing alerts of promotional events for the items are provided to participants—wherein the ongoing alerts are optionally triggered in part by a correlation of a physical location of a participant to a physical location of a merchant or other entity associated with the promotional event.

Another aspect of the invention concerns a method of marketing and promoting items comprising the steps: a) providing an item marketing computing system which is coupled through a network connection to a first item manufacturer computing system, a second item distributor computing system, and a third item data collection computing system; the item marketing computing system including one or more software routines to perform the following operations: 1) coordinating communication of first item event data to the third item data collection computing system from a group of participants sampling a first item; 2) calculating scores for the first item and/or for the group of participants; 3) communicating the scores and/or the first item event data to at least the first manufacture computing system; 4) process feedback data based on the scores and/or the first item event data from the first manufacture computing system and/or the second item distributor computing system which is specific to at least one or more the group of participants; 5) communicating promotional information to the third item data collection computing system relevant to the first item, and/or items determined to be related to the first item to the at least one or more of the group of participants.

The promotional information is presented dynamically from a manufacturer and/or distributor of the first item to a participant during the item sampling event and which promotional information is responsive and related to scores provided by the participant and/or other participants in the sampling event. The item sampling event is preferably associated with tasting a food or beverage, and the items are preferably wine.

Yet another aspect of the invention concerns an item data sampling collection computing device comprising: an electronic interface for capturing item sampling data from a participant for a set of items in an item sampling event; an item sampling processing routine that is adapted to: communicate at least some of the item sampling data with a remote computing system; present feedback data from the remote computing system, including advertising and/or promotional coupons for items, which feedback data is derived at least in part from a recommender system and is customized for one or more participants in the item sampling event; calculate scores and awards for the one or more participants based on evaluating and correlating their respective ratings provided on the set of items sampled during the item sampling event.

In some embodiments the device is part of a fixed electronic kiosk situated in a commercial establishment that serves food and/or beverages.

In a preferred embodiment the device is further adapted as a master controller of the item sampling event, such that the device communicates to other slave data collection devices operated by other participants and collects the item sampling data from such slave data collection devices. The device communicates directly to at least some of the slave data collection devices by way of a wireless connection. It can also communicate to the slave data collection devices through an intermediary server computing system.

Still in a preferred embodiment the device is further adapted with a sensor and associated routine to automatically determine identification and/or origin data for the set of items. The sensor is at least one of an image scanner, an RF sensor, and/or a barcode reader.

In some applications the electronic interface is adapted to be shared the participants during the sampling event and is customized for each participant during an item data capture session for each such participant. This aspect of the invention allows common feedback data to be broadcast to each of the slave collection devices at substantially the same time to permit simultaneous consideration by the participants of such.

In still other applications the promotional electronic coupons are configured to only be active within a first distance of one or more predetermined preferred establishments.

In another aspect of the invention, a data collection system for collecting data from participants in an item sampling event comprises: a portable master controller computing device; one or more portable slave computing devices; wherein each of the master controller computing device and the one or more slave computing devices having an electronic interface for capturing item sampling data from a participant for a set of items in an item sampling event; further wherein the portable master controller computing device is coupled to and controls data collection and data presentation for the item sampling event from the portable slave computing devices; the portable master controller computing device being further adapted with one or more software routines to: calculate scores and awards for the participants based on evaluating and correlating their respective ratings provided on a set of items sampled during the item sampling event; and present feedback data from a remote computing system, including advertising and/or promotional coupons for items, which feedback data is derived at least in part from a recommender system and is customized for one or more participants in the item sampling event. The portable slave computing devices preferably provide profile information automatically for a participant to the portable master computing device.

Another aspect of the invention concerns an integrated sampling event kit for sampling a set of consumable items comprising: an integrated package including at least the following: 1) the set of consumable items; wherein the set of consumable items are packaged in a manner so as to obscure their origin and/or identity from at least some of a group of participants in a sampling event; 2) a storage media including item data stored thereon in electronic form, including identification data for each item in the set of items. The storage media includes data and/or computing instructions adapted to be read by a portable computing device to assist with the sampling event data collection/analysis.

The storage media also preferably includes software routines and/or instructions for coordinating the sampling event, including compiling ratings for the set of consumable items, and determining awards for the group of participants in accordance with a sampling game procedure. Furthermore the storage media also preferably includes software routines and/or instructions for coordinating data exchanges between the portable computing device and a remote computing system which presents recommendation and/or advertising data to the portable computing device which is correlated with the set of consumable items in the integrated package.

A further aspect of the invention concerns a social networking website comprising: one or more social networking web pages and/or data feeds associated with a member of the social networking site; wherein the member can identify a social circle specified by links and/or associations to other member of the social networking site; a compilation routine executing at the social networking site and adapted to receive and process sampling event data for the member; wherein the sampling event data includes at least member event information relating to one of: 1) a set of items; 2) ratings associated therewith provided by the member; 3) scores and/or awards achieved by the member; 4) advertising materials presented to the member; the compilation routine being further adapted to automatically and selectively modify one of at least the one or more web pages and/or data feeds associated with the member and/or other members of the member's social circle based on the member event information.

In preferred embodiments the member can opt in or opt out of the compiling routine, the data feed is an RSS feed, and the sampling event data is compiled in real-time by the social networking site. A recommender routine is also preferably employed to correlate the member to other members, and provide recommendations to the member relating to other members and/or other items predicted to be of interest to the member.

Another aspect of the invention concerns a recommender computing system adapted to provide recommendations on a group of consumable items comprising: a first routine of the recommender computing system being adapted to collect at least a set of ratings for a set of consumable items from a group of participants using one or more electronic data collection devices during an item sampling event; a second routine of the recommender computing system being adapted to calculate correlations based on the set of ratings between at least one of 1) the group of participants and other persons rating the set of consumable items or related items; and/or 2) the set of items including at least item scores and participant scores; and c) a third routine of the recommender computing system being adapted to present recommendations on consumable items to at least some of the group of participants based on the correlations.

In preferred embodiments a fourth routine is used for interfacing and communicating the correlations and/or the recommendations to a social networking site and/or a computing system managed by a vendor of at least some of the set of consumable items. The recommendations preferably are further correlated to a group of establishments located within a first configurable distance from one or more of the group of participants. They can also be dynamically generated for the group of participants based on their physical location at a particular time. The final recommendation can further include an accompanying electronic coupon from a vendor or distributor of a consumable item.

Still another aspect of the invention concerns a method of conducting a contest for sampling items using a computing system comprising: providing a set of one or items to be rated during an item sampling event in which the items are sampled by a group of participants; automatically collecting at set of reference ratings for the set of items from a group of one or more reference raters using the computing system; automatically collecting at least a set of participant ratings for the set of items from the group of sampling participants during the item sampling event using the computing system; calculating participant scores for the item sampling event using the computing system. A winner of the contest is identified by the participant scores that are based on determining a correlation between each sampling participant rating provided for an item, and a corresponding reference rating provided by the one or more reference raters.

In preferred embodiments a participant having an participant rating for an item coming closest to a reference rating for an item is identified as a winner of the contest. Also, the sampling event is preferably controlled such that the participants are provided the set of items in the same sequence, and with a common set of accompanying consumable items to provide a common experience.

The reference ratings are preferably determined from ratings provided by other consumers of the set of items and/or individuals designated as experts. The method can also include one or more optional steps: providing promotional incentives and/or coupons to a subset of the group of participants based on their participant scores; and/or publishing the participant scores to web pages and/or other data feeds associated with the participants.

The event can also be managed through a dedicated event management website. Thus another aspect of the invention is directed to a website including a computing system adapted to conduct a sampling event for a set of items comprising: a first routine executing on the computing system for collecting at least a set of ratings for the set of items from a group of participants using the one or more electronic data collection devices during the item sampling event; a second routine executing on the computing system for calculating item sampling event data including at least item scores and participant scores; a third routine executing on the computing system for providing at least some of the item sampling event data through a network to one or more electronic systems associated with third parties involved in the making, distributing and/or selling of the items; a fourth routine for processing and sending promotional coupons and/or other electronic feedback from such third parties to the one or more electronic data collection devices or electronic accounts for the group of participants. The promotional coupons and/or other electronic feedback are coupled and dynamically adjustable based on a geographical location of the one or more data collection devices and/or a residence address of the group of participants.

Another aspect of the invention concerns a prediction contest for sampling items using a computing system comprising: providing a set of one or items to be rated during an item sampling event in which the items are sampled by a group of participants; automatically generating a set of predicted ratings for said set of items by said group of participants using said computing system prior to said sampling event; automatically collecting at least a set of participant ratings for said set of items from said group of sampling participants during said item sampling event using said computing system; calculating a correlation between said set of participant ratings and said set of predicted ratings for said item sampling event using said computing system; providing a report to said group of participants which contains feedback relating to said correlation. Steps (a) through (e) can be repeated for a different group of participants, so that a report can be published identifying a ranking based on a respective correlation for different groups of participants.

Yet a further aspect of the invention is directed to a method of conducting a sampling event for items with a computing system comprising the steps generally of providing a set of items; providing a first routine for capturing input data from a group of participants within an interactive graphical interface; the input data including: 1) numerical ratings for said set of items; 2) text descriptors for said items presented in a hierarchical menu; (c) capturing the text descriptors by displaying a first classification level with first descriptors, and in response to a selection of one of said first descriptors displaying a second classification level with second descriptors that are subclasses of the first descriptors; wherein a participant can select one or more of the first descriptors and/or said second descriptors; (d) capturing weighting information for the text descriptors that is based on a finger and/or pointing device position detected for the participant in the hierarchical menu.

With this data a taste profile for the participant is developed, including an associated mnemonic symbol representing the taste profile. The symbol is preferably graphical image representing one or more of an animal, a rotated text character, and a distorted text character, and an object.

Still another aspect concerns a game wizard routine configured to present an avatar that generates a prediction of participant ratings data and simulates ratings results for the set of items in the sampling event including prior to such event. In some embodiments the game wizard measures and present a performance of in prediction of participant ratings data. The wizard can also present suggestions to a sample event host for alterations of the set of items and/or the participants. The wizard can further calculate one or more diversity score(s) for a scheduled sampling event, which diversity score(s) identifies a value representing differences in ratings predicted for the participants.

Would-be participants can find and select upcoming sampling events based on a sampling event query that specifies one or more of: a discount coupon; one or more participants; a venue; a sampling item; predicted participant ratings; a predicted diversity score. During the event the game captures prediction data from the participants matching sampled unknown items to one or more identified items, timestamp data for ratings pricing data, origin data, etc. In addition a value of a rating trend measured for the participants can be measured during the sampling event.

Another aspect concerns an electronic interactive planning assistance tool for a social game comprising one or more game wizard routines adapted to execute on a computing system and to perform at least the following operations: (a) process an initial proposed set of sample items for the social game; and (b) process an initial proposed set of participants for the social game; and (c) simulate an outcome of the social game by predicting ratings likely to be made by said set of participants for said set of sample items.

A further aspect of the system concerns one or more systems which include a number of software routines for causing one or more computing devices to effectuate the above different aspects of the invention.

### DESCRIPTION OF THE DRAWINGS

The invention will be described with respect to the following drawing figures, in which like numerals represent the same features throughout the drawings, and in which:

FIG. 1 is an illustration of the main components of a preferred integrated gourmet item data collection/recommender/vending system of the present invention;

FIG. 2 is a flow diagram depicting the steps used in a preferred embodiment of the invention for collecting and analyzing ratings for items;

FIG. 3 illustrates the main components and operations used in a preferred back end process of the invention for compiling and updating ratings, users, etc. at respective e-commerce sites and other vendor facilities;

FIGS. 4A-4H, 4J, 4K, and 4M illustrate aspects of an exemplary embodiment of a website and/or game screens of the present invention configured to support gourmet item sampling events.

FIG. 5 illustrates a preferred process for conducting a competitive ratings game 500 as part of a gourmet item sampling event.

FIGS. 6A-6C depict interactive icons which are displayable within a graphical interface of a portable computing device (such as a PDA or cell-phone) and are adapted for assisting a preferred ratings process;

FIG. 6D is a flowchart showing a preferred process for capturing secondary data, such as taste, aroma, etc. with the interface shown in FIGS. 6A-6C;

FIGS. 6E-6F depict preferred embodiments of a game profile, symbol and matching tool implemented in accordance with the present teachings; and

FIG. 7 illustrates a preferred game planning tool implemented in accordance with the present teachings.

### DETAILED DESCRIPTION

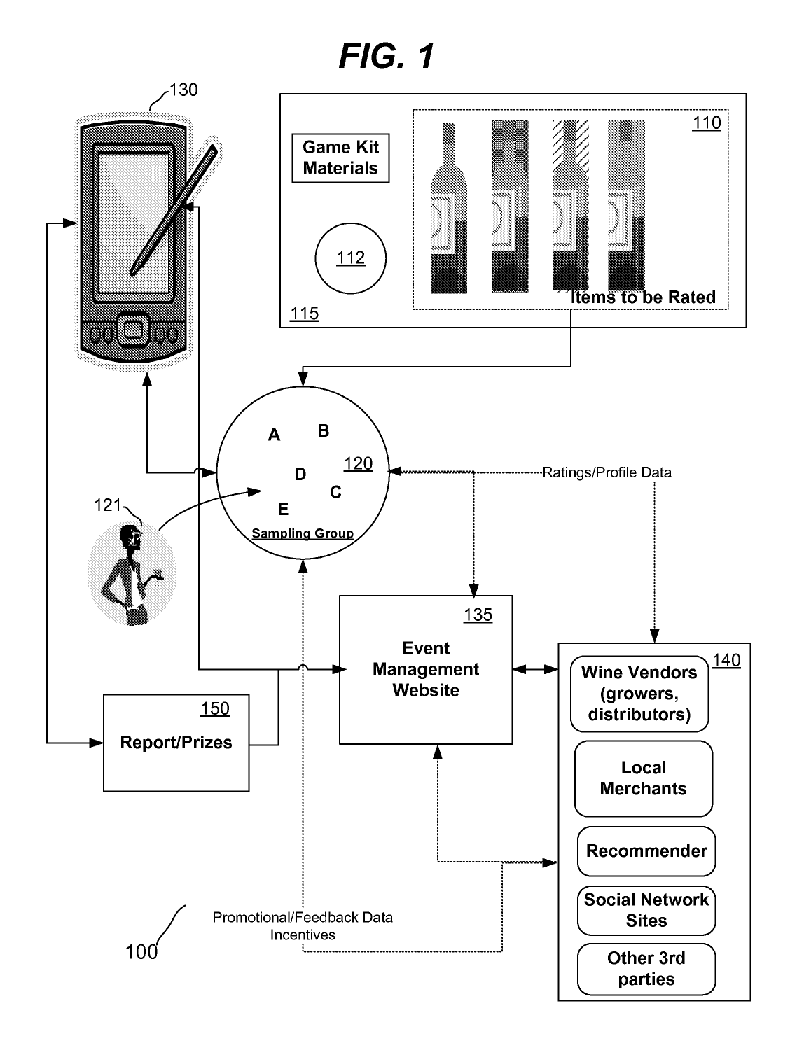

FIG. 1 is an illustration of the main components of a preferred embodiment of an integrated gourmet item data collection/recommender/vending system 100 of the present invention. A group of items 110 preferably include, for example, a set of distinct wines to be rated by a sampling group 120. While the items described herein are preferably gourmet consumable items, such as wine, cheese, etc, it will be understood that the invention has beneficial applicability to other domains and products where it is desirable to collect data from the public. Other types of items also lend themselves to group/social gatherings, discourse and ratings, such as book readings, movie previews/reviews, music pieces, sport teams, automobiles, political campaigns/candidates, other content such as news, stories, articles, images, and the like. Moreover while certain preferred vendors, e-commerce entities, etc. are identified, it will be apparent that other entities may be involved in the data collection, analysis and utilization processes herein.

In some embodiments, as explained below, the item set 110 may be in the form of a pre-packaged high end event “kit” 115 which includes all necessary items for conducting a consumer entertainment event for tasting and rating gourmet items, such as a collection of wines of a particular variety (i.e., Zinfandel, Cabernet, Merlot, etc.). Media 112 may be included with software and other data to allow an event host to manage and direct the event from a local computing platform, such as a personal computer. In some cases a basic data collecting tool 130 (discussed below) for executing the routines on media 112 can also be included since the cost of electronic components is constantly decreasing. The output of the data collecting tool could be collected by downloading it to another computing platform.

The items 110 may be in their original packaging/labels, or they may be re-packaged into generic containers (not shown) with no identifying information to permit blind sampling. In the case of original packaged materials the kit can also include preprinted wrappings/adhesive labels (not shown) for masking an existing label on an item and so as to facilitate a blind tasting if desired. In the case of generic containers they can be adapted to include convenient markings thereon to identify suitable pouring amounts for a sampling. For example a 750 ml bottle may have 15 markings corresponding to 50 ml each.

This “complete event in a box” approach may also be attractive for parties, corporate retreats, etc. at locations where it is desirable to have all components of an entertainment event self-contained in a single package. It will be understood of course that the composition of the item kit will be a function of the specific items to be reviewed and is expected to vary between applications. For example in the case of a political discourse gathering the items may be audiovisual blurbs or ads for a candidate. In the case of movie/music embodiment the items may be snippets of content, and so on.

Sampling group 120 includes a number of participants 121 who are designated A, B, C, D, E, etc. in FIG. 1. While in a conventional consumer event the participants are human, it is not unreasonable to assume that at some point in the future automated robotic entities may be involved in evaluating and rating the taste and desirableness of consumable items. The site where the sampling group 120 is congregated may be at a consumer residence, a restaurant/bar, a wine cellar, or any other convenient assembly location. The sampling group 120 may be geographically distributed in some cases as well so that a “virtual” wine tasting could take place electronically.

In a commercial establishment embodiment, the set of items could be implemented as selections of a standalone unit within a well-known electronic dispensing system used for providing small samples of wine. By adapting such system to provide blind tastings, the invention could be implemented in conjunction with standard electronic debit cards typically employed with such applications. In such instances the card may in fact be programmed to record the customer's selections (such as which station the customer took a sample) so the customer does not have to remember such details. At a later visit the patron's card could be scanned to identify which wines they liked during the prior visit, thus increasing the odds they will find a satisfactory selection.

In a preferred wine tasting party embodiment the participants 121 employ a data collecting tool 130 for collecting event data which, in a preferred embodiment is a portable device such as a PDA (for example a Blackberry), a cell phone (for example an iPhone) or the like. A small computing system such as a notebook or PC could also be used if necessary. The data collecting tool 130 includes conventional networking capability (wired or wireless) to exchange/communicate event data, including with an event management website 135 discussed further below.

In one application the participants each include their own data collecting tool 130 which allows for more flexibility, privacy, etc. during the event data collection process. Furthermore other offers, incentives, etc. from vendors can be communicated more easily and directly in such fashion. However even a single data collecting tool 130 can be used as explained in further detail below. Data collecting tool 130 may also employ speech recognition and natural language techniques for collecting the item ratings data. These facilities may be built in directly within the device, or may operate in a distributed fashion with the assistance of server computers in a networked configuration.

A variety of mechanisms can be used for collecting the identifying information for each of the items 110 and profiles for the participants 121. Typically speaking an item to be rated will include an RF ID, a bar code, a label or other identifier that can be examined and correlated uniquely to a particular item. This data can be input manually to data collecting tool 130, or in some cases, can be captured electronically directly from the item itself. For example an RF reader, a bar code reader or image capturing device (i.e., an onboard camera not shown) can read/scan an identifying label for an item. The image/bar code data can then be decoded and correlated with conventional software to a determine a match from a database of items (not shown) to identify the item in question. The images of the items can be stored for later use in the game mode, in which participants are asked to match an item being sampled to an actual label, wine, etc. In some cases, as in a high end gourmet kit embodiment noted above, a package of items 110 may include electronic ID information stored on a conventional memory media device such as a USB card, a memory stick, and other similar devices. Other examples will be apparent to those skilled in the art. Profiles for the samplers 121 can be determined automatically either from prior records for such entities, information gleaned from their respective data tools 130, from a social networking site profile, etc. In some instances the profiles can be received as part of a data sharing arrangement for members, such as offered by the Google or Facebook Connect programs for example. In other cases profile data is simply entered manually as desired to data tool 130.

Other event related data (such as situs, date, time, control conditions) can also be collected as desired. If the event is created by a member of a social network, the timing, location, and other pertinent details can be posted for the benefit of their social contacts. Social contacts of the user can thus query and find relevant events of interest. In other embodiments the existence of events in a particular geographic area can be detected automatically (through location services on a mobile phone) so that prospective participants can easily find tasting groups. In this instance a user might be in a particular area of a city, and through a simple query be able to attend an event on short notice.

The event data, including profile data and item data is (optionally) also communicated to an event management website 135, and in some cases directly to a variety of interested commercial entities 140. In the latter case this can include, for example, one or more brick and mortar entities, such as wine vendors (growers, distributors, etc.), local wine merchants of wine, etc. and e-commerce operators such as wine recommender sites, social network sites and other online operators.

Such entities 140 can similarly generate their own respective feedback, promotional and other related data for the event, which is pushed back to one or more data collecting tools 130. For example upon detecting that a participant 121 has rated a particular wine with a favorable rating a wine vendor could push an electronic coupon to such participant either electronically by data collecting tool 130, by email/electronic message, and/or by conventional mail. In instances where the vendor receives advance notice of the event, they can opt to send samples or promotional items ahead of time to gain access to the participant opinions and samplings. Other examples are discussed below.

For some applications data collecting tool 130 is also responsible for managing, reporting and analyzing the results of the event data as noted at 150 to determine potential prizes and the like for individual participants. This analysis is preferably done dynamically as the item rating data is collected, but could be done at the end of the process if necessary. The nature of the competitions, games and prizes is discussed further below.

In other cases the managing/reporting/prize analysis of the event may be done remotely by event management website (or another site) 135 which has a separate computing system (not shown) which has more resources, is more adapted for such task, etc. The report/prize data can then be communicated back to the participants as desired during or at the end of the event.

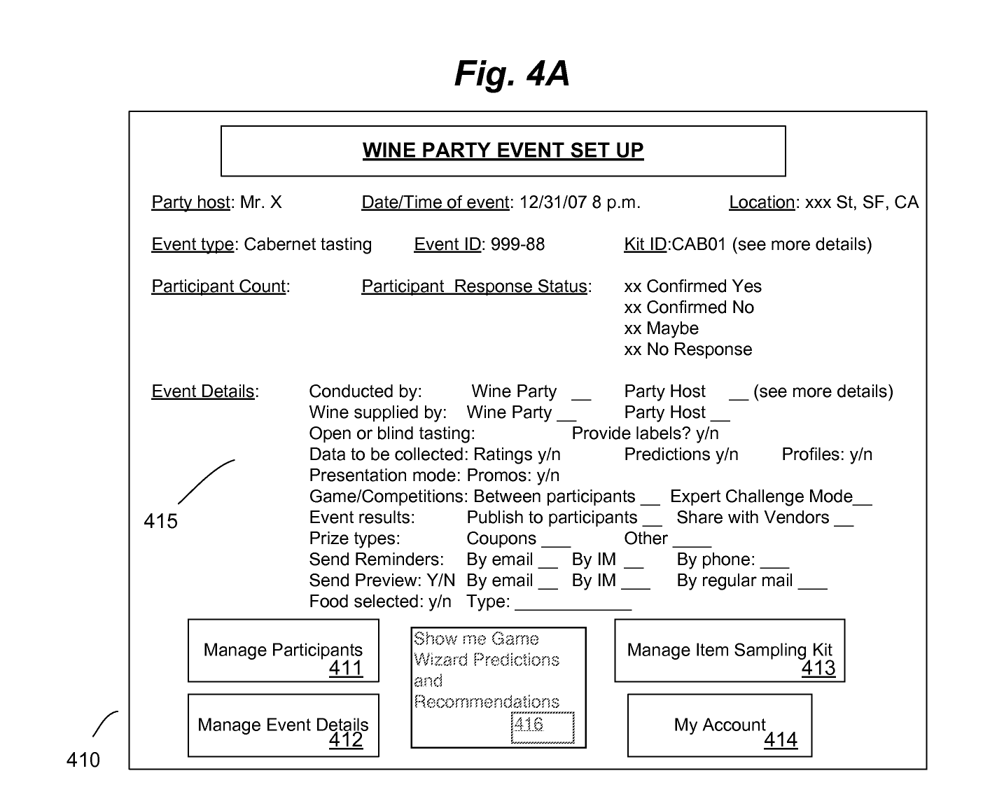

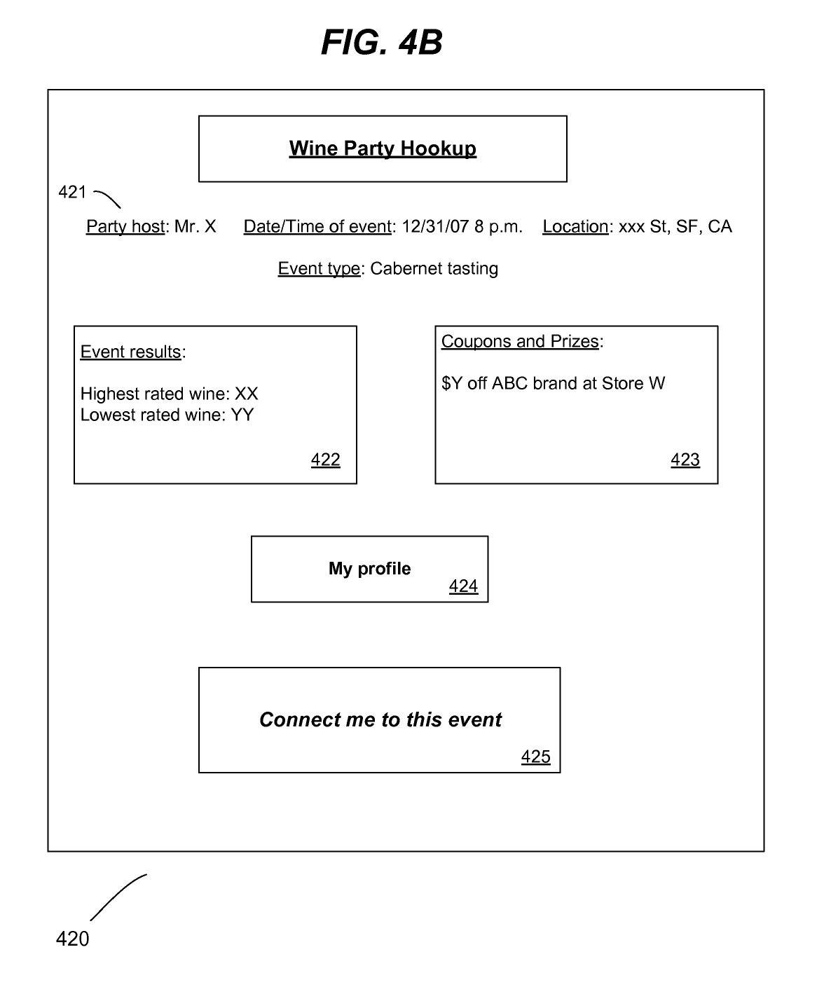

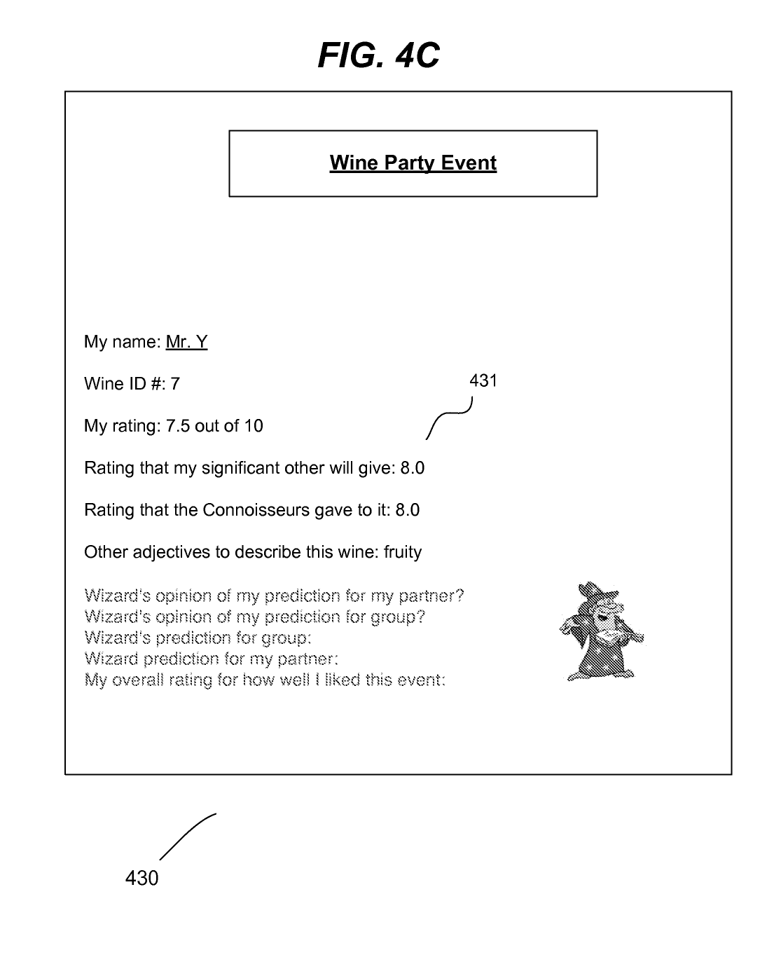

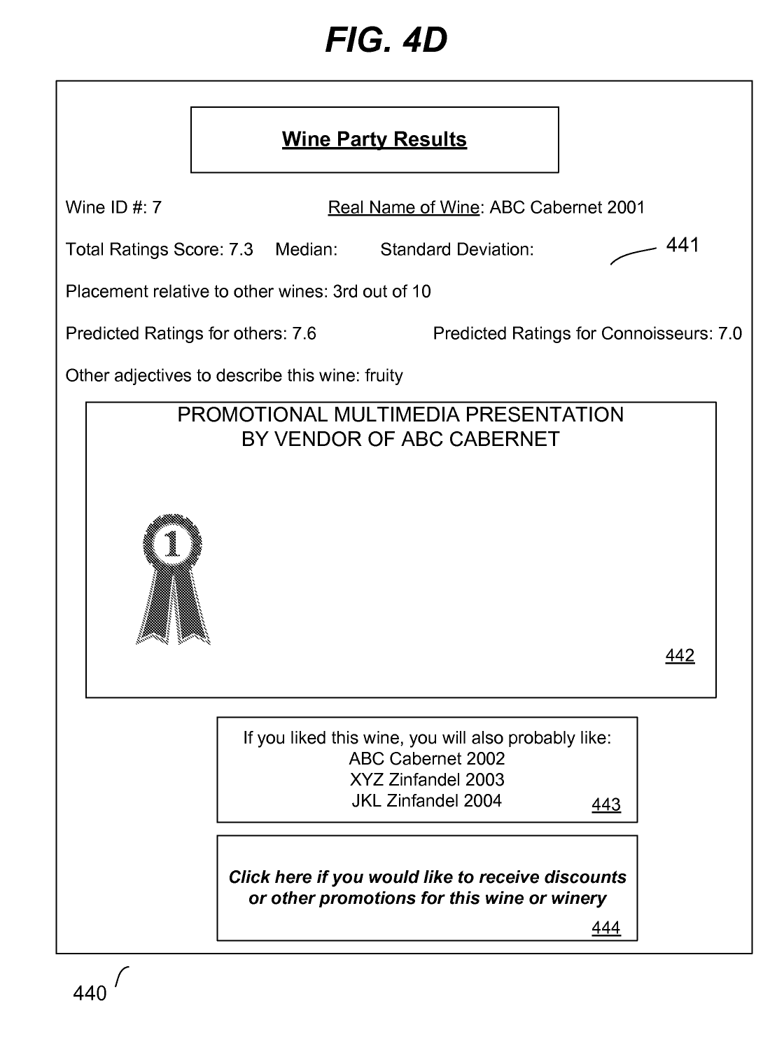

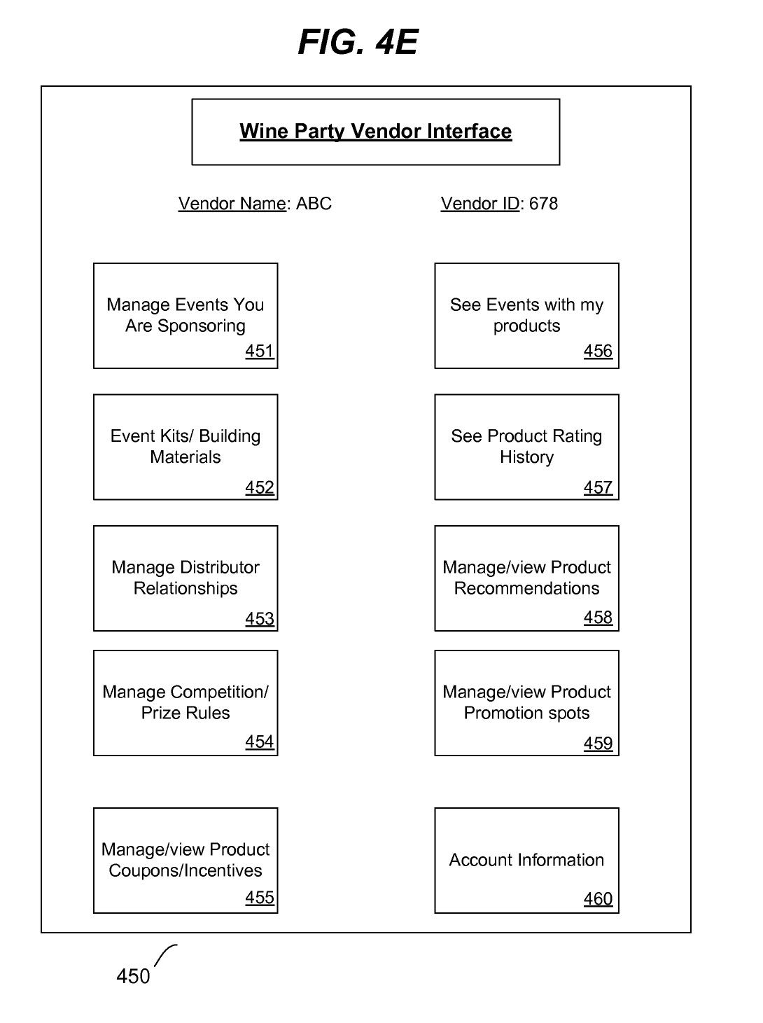

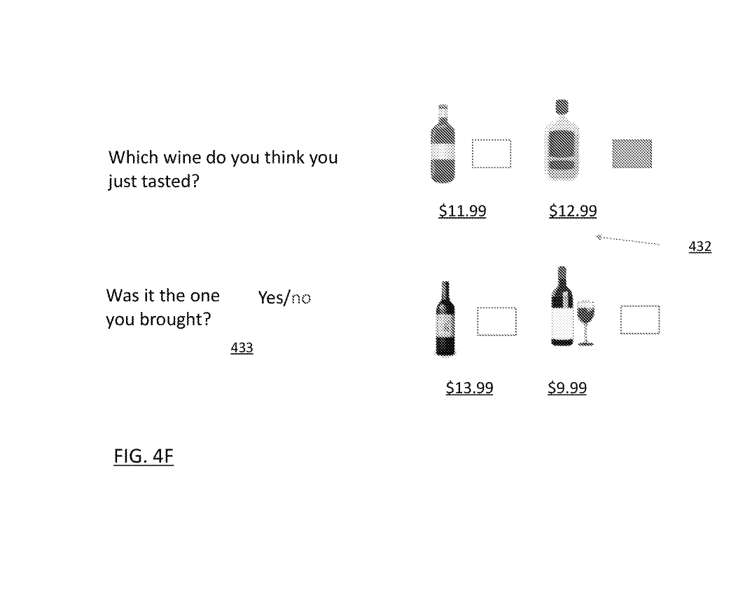

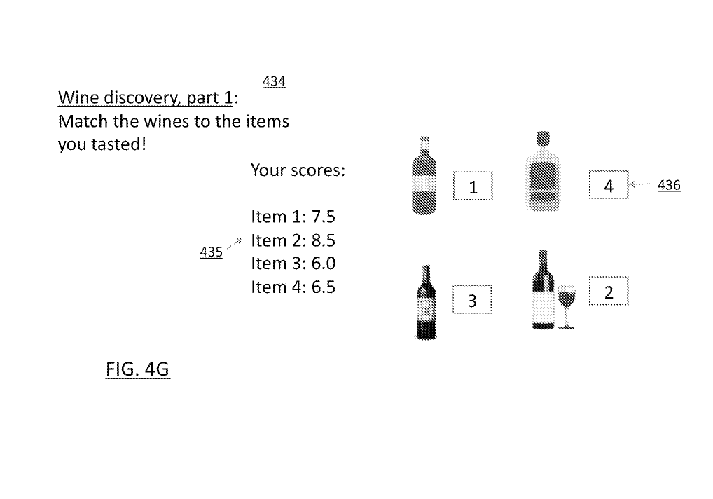

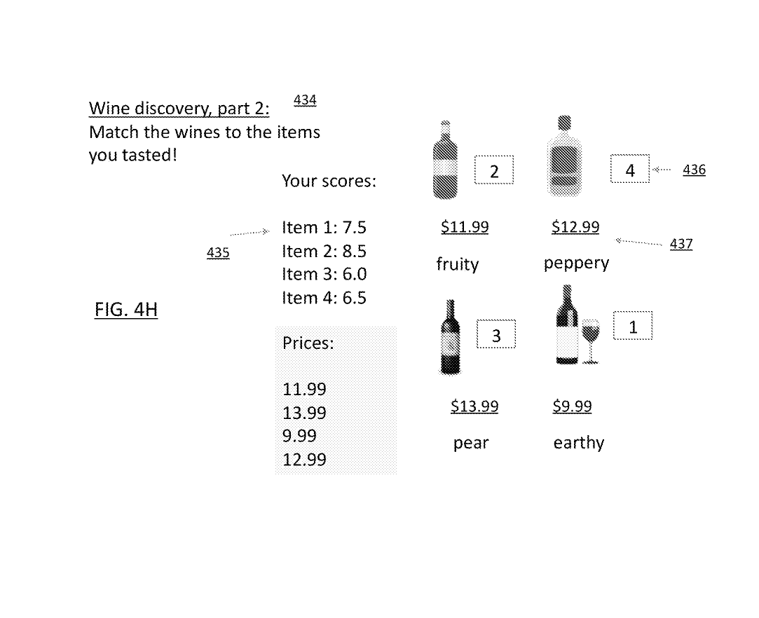

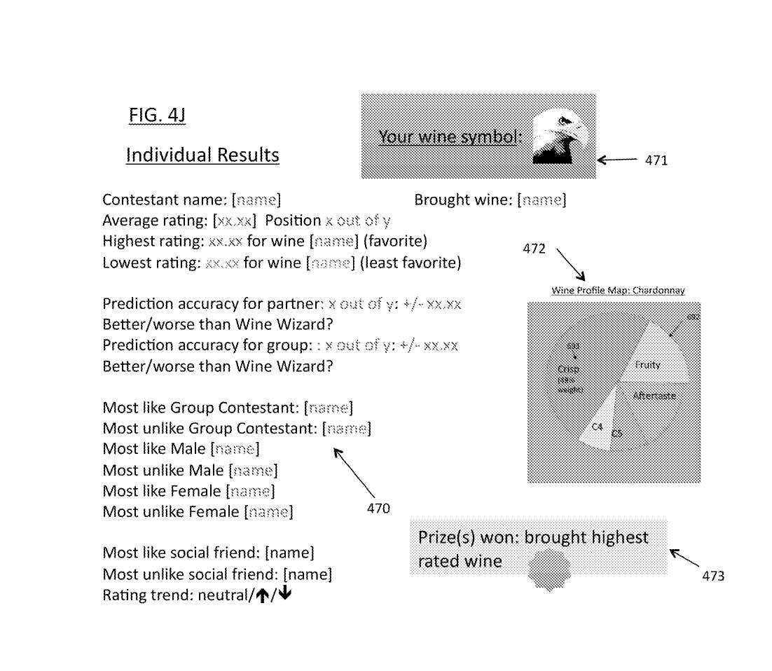

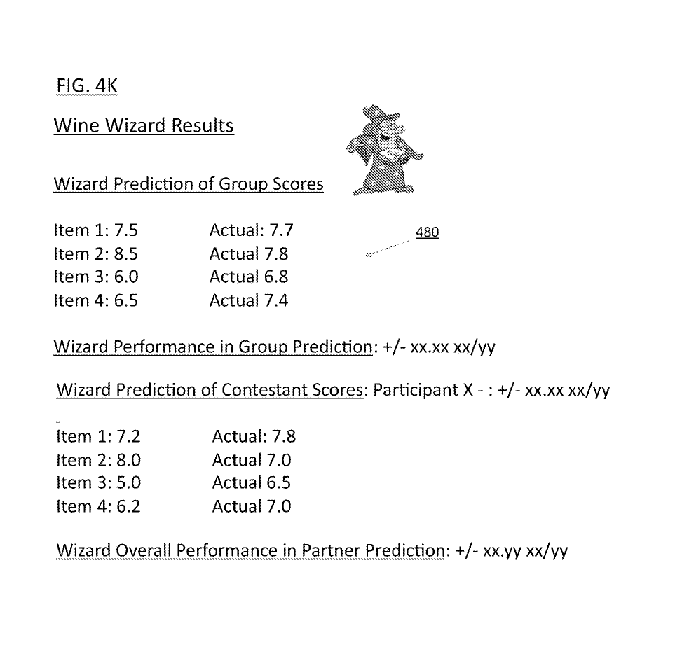

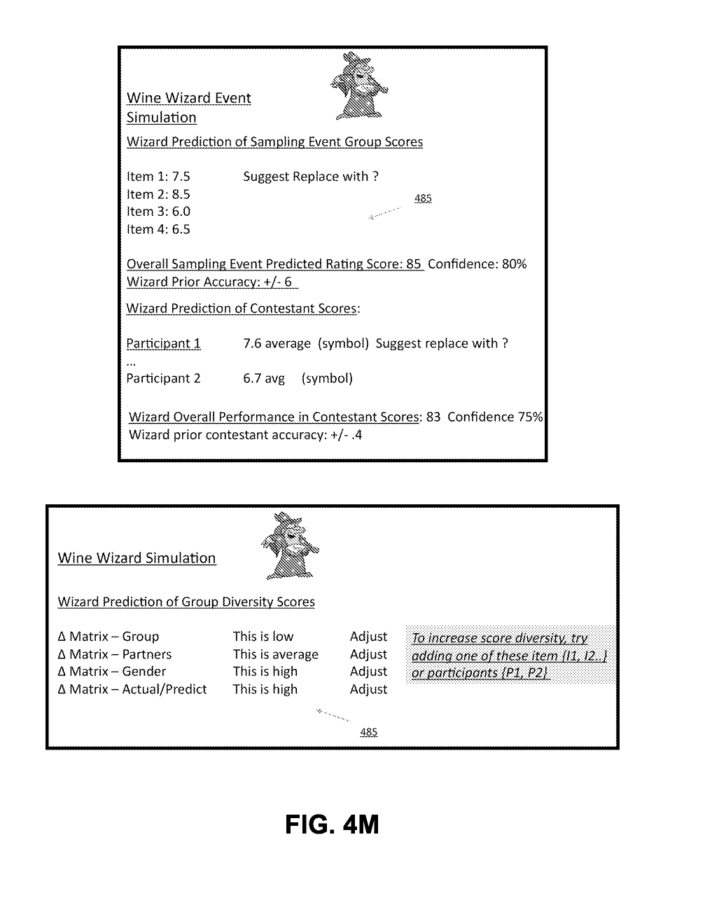

The general features and interfaces of event management website 135 are discussed below in more detail in connection with FIGS. 4A to 4K. Generally speaking this website can be programmed with suitable intelligence to effectively manage a number of ongoing events for hosts and participants. The events of course can differ, but for purposes of illustration a wine sampling application is presented herein as a preferred embodiment.

The event management website 135 basically coordinates with online users to help them set up and operate sampling events for wine. The website can also be configured to operate all aspects of the event if necessary. So, for example, during the event itself, the ratings data can be sent and processed directly at website 135, and it can coordinate between respective entities 140 to determine appropriate feedback for the participants. This has the advantage of centralizing the event data and management for multiple vendors. It will be understood that the interface and features shown in FIGS. 4A to 4K and FIGS. 5, 6A-6F can also be implemented locally on a handheld device as well.

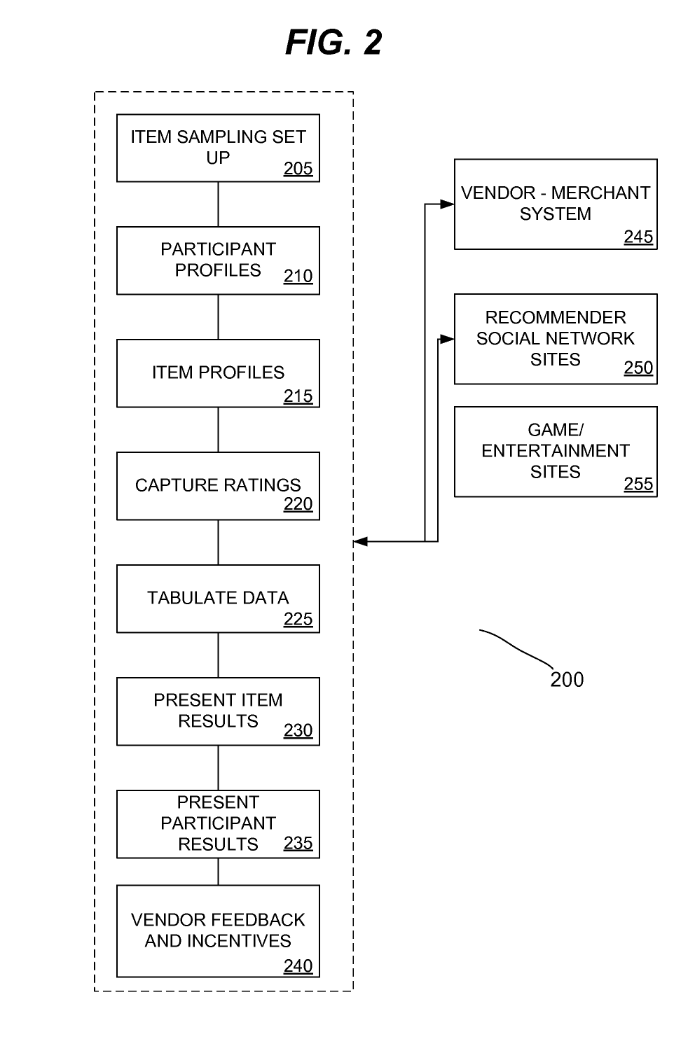

FIG. 2 is a flow diagram depicting a data collecting operation 200 of a preferred embodiment of the invention for collecting and analyzing ratings for items. At step 205, the items to be rated are sampled are set up in appropriate fashion for sampling. As noted above this could take place at consumer's residence or in a commercial establishment such as a restaurant, wine tasting room, bar, etc.

The setup step 205 should also assist an event planner or manager in determining the format to be used for the sampling, including, for example, the type of data to be collected, rules for participants, and rules for scoring/prizes. As an example the set up step 205 may specify a number of event parameters such as:

a ratings scale to be used in a scoring process;

whether items must be given different/unique ratings;

whether ratings scores are to be normalized for each user;

whether (and which) certain types of ratings scores should be weighted or eliminated from consideration in a final scoring process;

what types of ratings are to be provided by participants (see below);

whether event data, including ratings, participant profiles, etc., are to be shared with other entities, and, if so, which ones;

whether prizes/awards are to be employed in the event, and, if so, what types (explained further below);

whether one or multiple data collecting tools 130 are to be used;

whether the event is to be registered, and, if so, at which establishments;

whether there are price/cost constraints (i.e. the items must fall within a certain range)

what kind of food, if any, was served as an accompaniment (in the case of a wine tasting).

These are but examples of course and other potential event rules will be apparent to those skilled in the art based on the particular application. All of these parameters may be entered into a suitable event set up interface of event management website 135 as explained below. An example of a preferred data screen for use with an event management website 135 for this purpose is shown below in connection with FIG. 4A.

Returning to FIG. 2, at step 210 the individual participant profiles are obtained. Again, as noted earlier, this may be secured from preexisting database records, from information gleaned from a participant's data collecting tool, etc. Alternatively it can be entered manually to compile an event participant list using an interface of event management website 135 as seen, for example in FIG. 4B. As seen therein a user can simply connect to an event in progress at the appropriate time.

Again in FIG. 2, the participant data preferably includes such information as age, sex, residence address, and other similar demographic data. Other data can be collected as needed for particular applications, such as income, occupation, place of employment, passwords, social security numbers, driver license nos. credit card nos., photos, etc. subject to privacy considerations and participant comfort level. In some applications it may be desirable to collect other account data for participants, such as food/wine club memberships at local markets, email accounts, social networking site IDs/accounts, etc. This additional account data can be used more easily by merchants to identify and correlate incentives and other feedback correctly to the right individual. As an example the event data can be more easily captured (along with images, photos, audio data) and published as content on a participant's social networking page in an environment such as that offered by Myspace, Facebook, and other similar sites.

At step 215, the items to be rated are analyzed as noted above to collect their identifying criteria. For example in a wine tasting event, the items would be individual bottles of wine from a particular vendor, including a variety of grape, year of bottling and retail cost if desired. Generally speaking, website 135 is enabled with a feature (see below in FIG. 4A) that allows a host to merely specify these parameters so that the wines are automatically selected, packaged and delivered to the event host prior to the event date. In other cases website 135 may merely provide a list of suggested items to be included in a sampling, which list can be shared and communicated to other participants to ensure proper representation.

Accordingly in certain embodiments where the participants bring the items directly, they may be told to restrict the items to wines of a particular grape type and a particular price range to limit variability and improve the usefulness of the collected data. To increase the entertainment value the website event manager, or an event planner or organizer may “seed” the item set 110 with either or both: a) highly rated wines outside of the price range and which are considered significantly superior; b) poorly rated inexpensive wines that are considered inferior. These additional item points can further interject interest in the game as the guests can be told of such items and be asked to guess and discriminate their presence among another set of items during a blind taste test.

The data is captured manually or automatically as desired. In some instances it may be possible to have event management website 135 coordinate with local merchants using “registered” data events, in the same manner that weddings and the like are conventionally registered. In such cases the purchase of the item in question could be correlated automatically by software at the event management website 135 with the correct event to avoid further data entry impositions on the participants. By registering events it is also possible to avoid situations where guests bring inadvertently duplicate items. Furthermore the use of registered events allows an event organizer to monitor the state of progress of item collections (see below) and determine the composition of the item group, and thus determine whether supplemental purchases/items are needed to augment the samples.

During step 220 the participant ratings, predictions and other desired event data are collected, preferably at the time of the event and in real-time while the participants are involved in the event. In a preferred embodiment at least the individual item ratings are collected. In addition, to account for potential data distortions, the ratings can be associated with a timestamp, a location, a venue, etc., so that any biases can be accounted for in later data processing treatment. As noted below for example, empirical data suggests that the rating for a particular wine item will vary according to when it is consumed in a sampling event, or the mood of the crowd, or the host, the venue, etc.

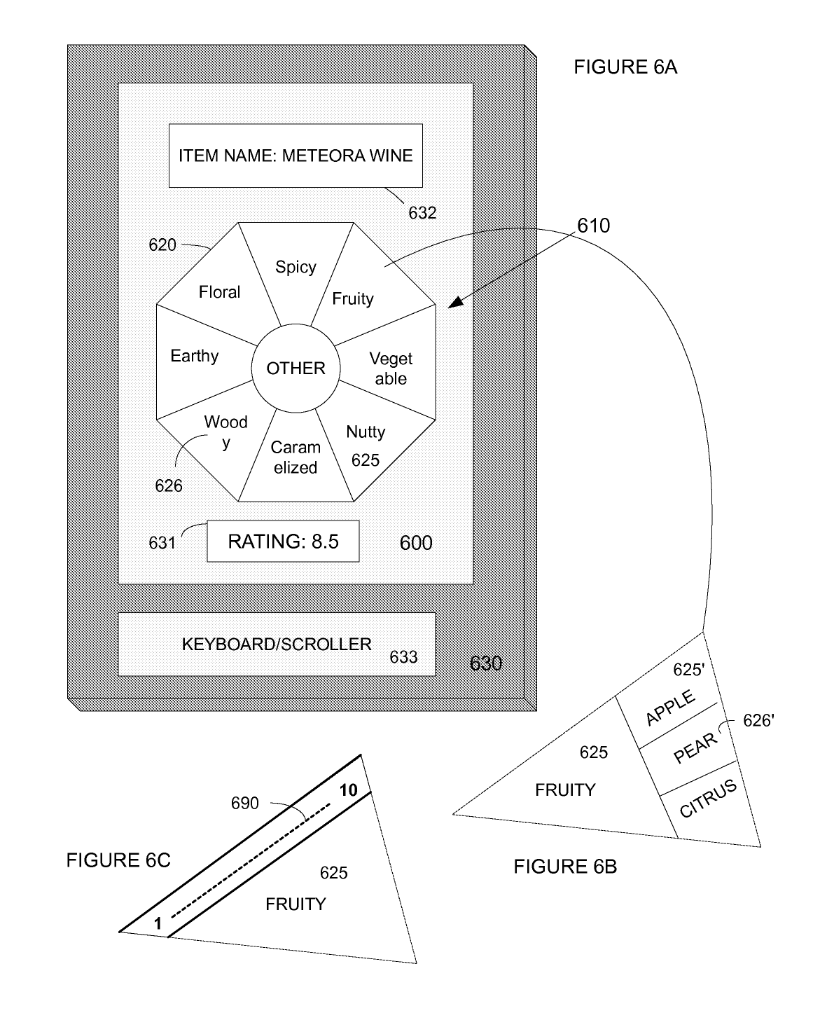

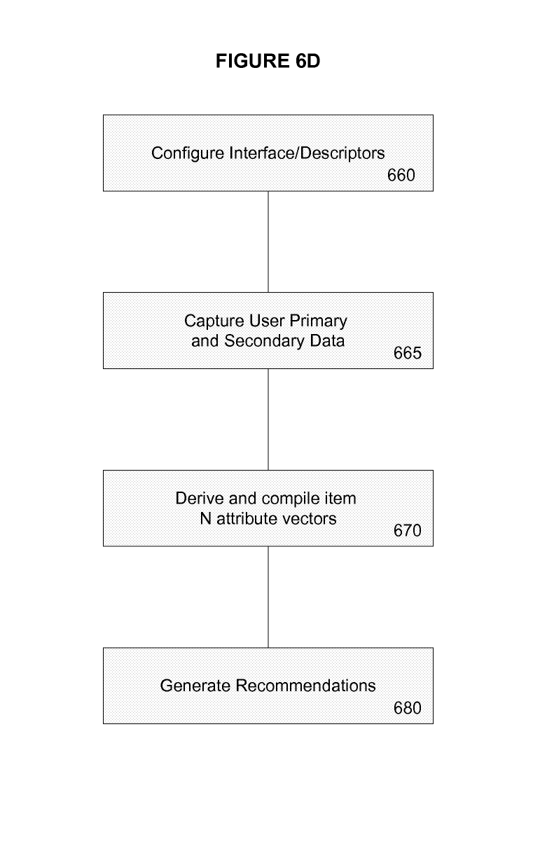

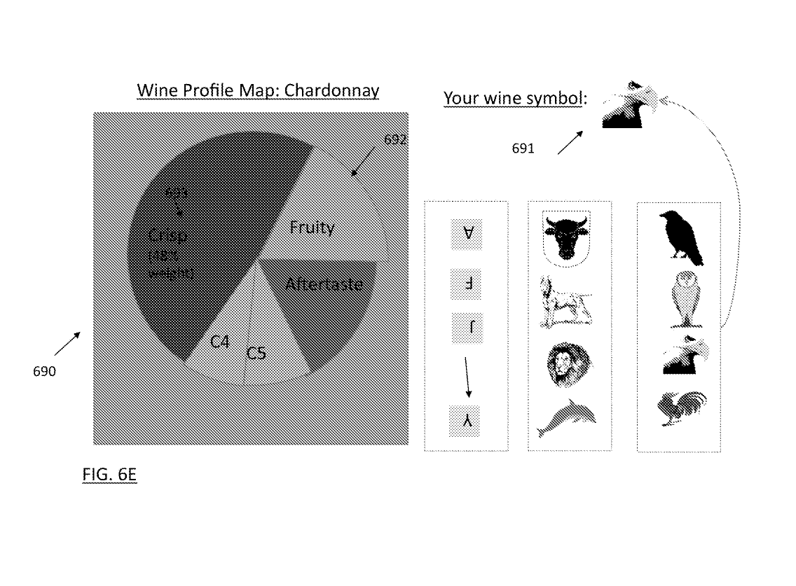

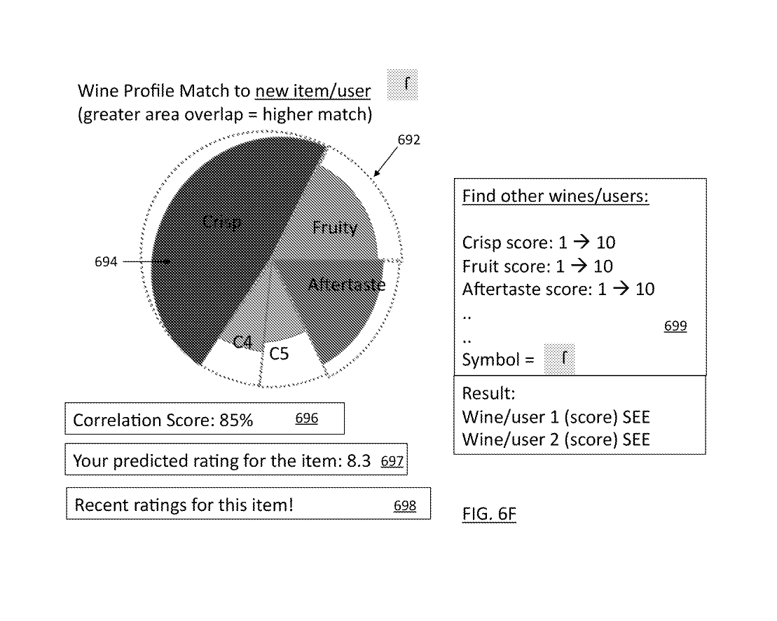

The data can be collected by the event management website 135 (as seen below in FIGS. 4A, 4C), or by another program executing on data collection device 130. A preferred interface that is well adapted for capturing both wine ratings and user impression data is shown in FIGS. 6A-6D and may be employed with embodiments of the invention to capture item characterization data faster and easier for participants. The interface is pre-configured with appropriate descriptors to help prompt participants to provide further ratings that would otherwise be difficult or beyond their experience base to expressly clearly and concisely. The interface is also preferably interactive so that as users select broader descriptions (“fruity”) the screen of a device can present an expanded view with specific selections (apple, pear, etc.)

In the case of wine items at least, the identity of the items is preferably concealed so that the raters are not aware or biased by the source of the item. In the “kit” arrangement noted earlier it is possible that the individual items can be labeled with generic identifying information that conceals the true identity/source to preserve the integrity of the blind tasting.

In addition to rating data the event can be enhanced by the addition of other ancillary data that is used to further increase the interest and enjoyment of the participants. For example the event may be staged as a form of wine tasting game or competition in which participants are solicited not only for their own opinions of the item in question, but also for their predictions on: a) how their significant other would rate the item in question; b) how the other members in the sampling group would rate the item in question; c) how an expert or connoisseur would rate the item; d) a cost for the item; e) whether they would recommend the wine to a good friend; f) whether the wine is one that they brought with them; g) which one label matches the item in question, etc. Other prediction/opinion data can be captured, of course, and the invention is not limited in this respect.

As noted above, in some applications, particularly involving wine, the ratings data routine can be programmed to provide suggestions to the participants to capture other data specific to such product, such as the particular tastes or smells evoked by the wine, what food they may have had an accompaniment, and the names of any other beverages they may have consumed immediately before. This feature makes it easier on the participants to provide specific feedback data and allows them to learn about other qualifications/criteria used to judge the quality of wines. Similar options could be made available for other products using an interface similar to that shown in FIGS. 6A-6D.

The data is input either by touchpad, keyboard entry or speech by each participant into their respective data collecting tool 130 which is configured to manage the event in case event management website 135 is not used. In the case of a touchpad or keyboard entry, it is possible that other icons and interaction mechanisms could be provided to signify feedback. For instance, an iPhone like device could have an icon of a wine glass that the user interacts with to express a rating. This could be done by filling it to a certain level (1-10) or emptying to express a rating. In another case the size of the glass could be altered from smaller to larger with a finger touch to express a rating. Alternatively a visual graph or spectrum could be employed to express a more subjective rating.

In the case of speech input a speech recognition routine is used to decode words and phrases from the participant, typically in conjunction with a natural language engine. Furthermore in some cases it may be desirable (with the permission of the participants) to record and journal the discussions of the participants for each item for later review and study by vendors. These types systems are well-known in the art and thus are not discussed herein.

Again the act of collecting data can be managed through website 135 or locally as well. For example in cases where the participants have individual collecting tools 130, a main event organizer can coordinate the collection of data from each individual device by syncing up and collecting data from such separate devices—preferably through a wireless connection. Alternatively such devices can connect to website 135. Thus each participant tool 130 connects into an event organizer system operated on a main data collection tool 130 locally or remotely at website 135. This allows a large group of individuals to be managed from a single device platform for the convenience of the group, as the bulk of the compilations, tabulations, etc. can be done with a single tool. It should be noted nonetheless that the results of the event, including a report on item ratings, and other related event data, can be pushed to each individual device as desired.

If only a single data collecting tool 130 is employed, it may be desirable to shield the data input from respective participants. To accomplish this, an electronic shield or screen may be imposed in between individual participant entries. Thus each participant would be required to enter a personalized code to gain access to their data, and would only see their respective data input screens, and at the end of their turn, they would pass on the device to the next participant. The main data event routine would then automatically blank the data from the participant within the collection screen and present the next participant with the appropriate fields ready for data entry.

An example of a data screen for use with an event management website 135 or mobile game routine is shown below in connection with FIGS. 4C, 4F, 4G, 4H and 6A-6D. These interfaces engage the user during the event process to solicit relevant data and are explained in further detail below.

At step 225 the ratings and prediction data are tabulated in accordance with the objectives and parameters set for the event. Thus the item ratings are evaluated and computed to determine a final overall rating/ranking for each item. An example of options available for ratings selectable by a host from an event management website 135 is shown below in connection with FIG. 4A.

As noted above the ratings from participants may be adjusted or normalized in some instances to provide better comparisons of data. This (and the other functions noted herein) may be done locally on the data collecting tool 130 by a mobile app, or remotely at a server. Rankings and ratings may be presented with or without such normalizations.

More interesting, perhaps, are not the item rankings or relationships per se, but the participant ratings and relationships to each other and the sampled items, their friends and other users. For example, a determination can be made of the following:
1. A ranking of couple ratings comparisons, such as by identifying which couple provided the closest ratings results (as measured, for example, by a conventional least squares calculation);
2. conversely, within such set, which couple provided the most disparate ratings results (again as measured, for example, by a conventional least squares calculation);
3. which pair of people in the group provided the closest ratings data;
4. which pair of people in the group provided the most disparate ratings data; all of the above can be presented in some form of table or visual graph identifying associations between individuals for ease and convenience;
5. correlations between each participant and their deviation from aggregate group scores; for example, for the highest rated item, identifying the person who rated such item as the highest within their scores;
6. conversely, identifying the person who subjectively gave the lowest rating to the item rated highest by the group;
7. similarly, identifying the person who gave the highest rating to the item rated lowest by the group;
8. along such lines, identifying the person(s) who gave the lowest rating to the item rated lowest by the group;
9. identifying the highest rated items rated by sex or age groups;
10. identifying and ranking of how well persons predicted their partner scores;
11. identifying and ranking of how well participants predicted a group score;
12. identifying and ranking how well participants were able to rank the pricing of the wines based on actual cost
13. identifying and ranking how well participants were able to detect their own selection in the tasting (i.e., “is this wine the one you brought”? Y/N)
14. identifying and matching the individual items sampled blindly to labels of the items brought, or even other items; (i.e., “match the item you sampled to this list of labels”); the items could be quizzed one at a time (“which label do you think you just consumed” and presenting N options) as a 1:N comparison or all at once at the end of the sampling event (“match all the items you sampled to a corresponding label”) on a N:N basis. See FIG. 4F.
15. identifying and ranking importance key features of the items preferred by the user by querying and retrieving information for the items, and then sorting and ranking characteristics for a particular user; for example the user could be determined to prefer wines that have a crisp and fruity flavor based on matching their ratings to other items in an item database 605 (see below);
16. identifying and profiling the user in comparison to other users; the user's preferences can be used to model their behavior as corresponding to one of N different tasting preferences; the tasting models are derived based on grouping item characteristics, wine features, etc.; for example a wine universe may include 10-20 nominal tasting profiles which are used to categorize users for convenience in identifying and labeling products.
17. identifying an overall trend of the participants ratings over time, to see if they generally increase, decrease or remain the same during the event relative to their earlier scores, and/or relative to other participants.
18. identifying any prizes or awards calculated by the system for the user;
19. These correlations, and others, can be compiled to provide insights to and for the benefit of the participants. An example of the output that can be provided for each individual is shown in FIG. 4J, which further shows a user's calculated wine profile map 472, describing which features were found to be best correlated to the user, and in which proportions. The user is also assigned a wine “symbol” 471 which is calculated as noted above by assigning the user to one of a set of discrete wine tasting profiles. This symbol, as noted below, can be used by a user as an easy mnemonic or remembering device to find items and other users sharing common taste interests.

In some applications where it is desirable to add a gaming or competitive element to the event, it is possible to correlate the scores of participants against other third party references, such as wine experts, connoisseurs, and the like. The participants can also elect to compete against a “wine wizard”—an electronic agent controlled by the system software and presented as an interactive avatar—as noted below. The optional wine wizard (see FIG. 4K) makes predictions of the group and partner ratings, and discusses/reveals such ratings to the participants during the event in real time to increase the enjoyment. These options can be implemented within an interface such as shown in FIG. 4A.

Back in FIG. 2 during step 220, the participants are permitted to enter their predicted scores for what such third party references had provided to such item. Awards, prizes, coupons or other incentives can be provided by wine vendors and merchants to promote interest in such contests. The contests can be structured as a “predict the score of the experts” game to solicit predictions from participants and as a basis for further recognition within the contest.

As noted above, the invention allows participants to provide further predictions on how other members in the group may rate a particular item. For example, spouses and other pairs of participants could be asked how their significant other would rate the item in question. This part of the tabulation provides interest to the participants as it helps to identify those couples with the most and least similar tastes.

Similarly, predictions made by participants about group tastes, expected costs, and recommendations are also useful for both entertainment purposes within the group as well as data collection for entities 140 mentioned earlier, and can be captured through the interfaces noted in FIGS. 4C and 4F-4H. By presenting the data collection in an interesting and entertaining manner, participants both enjoy the experience and provide valuable data to the various item merchants and other e-commerce operators. As noted earlier, the event data may be collected and uploaded dynamically to various entities directly or through event management website 135, such as to vendor-merchants 245, social network and recommender sites 250 and game/entertainment sites 255. This would have the benefit of allowing such entities to deliver feedback and/or content related advertising to individual participant's on-the-fly while the experience and impressions are fresh on the minds of such individuals, and directly in response to the ratings and prediction data provided by the participants.

In some instances entities 140 can be given access directly to tabulation data from step 225 as well, as maintained by a master event organizer routine executing on one or more of the data collecting devices, or at website 135. This allows for other dynamic recommendation “matchings” that can be provided in real-time to the participants. For example, a vendor 140 may note that individuals A and B are highly correlated in their wine (or other item) preferences. It may also be known (from other data mining resources) that certain wine preferences are also highly correlated to other preferences in art, literature, food, movies, or some other endeavor. A vendor computing system (not shown) can thus draw upon such recommendation technologies and give a suggestion to either or both individuals A, B based on their respective prior preference expressions.

So if participant A had recently purchased title X from Amazon, or rented movie Y from Netflix, these informational tidbits could be communicated to participant B—who is known to be highly correlated with A's tastes—in the form of friendly conversational ice breakers for such individuals to facilitate social discourse. Similarly the system could identify the fact that both A and B had recently seen or reviewed the same movie very highly, and this fact could be shared as well with both participants to increase enjoyment for the group.

Therefore, one corollary aspect of the invention allows for situations in which advertising and/or other solicitations for opinions on unrelated items are secured during ratings capture step 220 from participants. Thus a movie or book vendor 140 may be permitted to piggy-back on the event and make specific targeted queries interspersed during the event ratings periods to garner further opinion data, and/or provide targeted ads based on correlating such ratings to a database of other items and/or an advertising stock. Other advertisers could employ the same function for their products/services.

During step 225 a user's wine profile is also determined, with reference preferably to the characteristics of the wines that he/she rated highly as noted below. This computation takes into account which features appear to be most relevant to the user, and in which proportion. In addition the user can be assigned to one or more of N distinct wine profiles based on defining and dividing a wine tasting space into N different models. Each model can be determined statistically by arranging and classifying the wine features, ratings, etc. using known techniques. A correlation of the user to each model is then performed to see which profile the user best belongs to.

Each profile can be optionally assigned a symbol (which can be an animal, an inanimate object, a distinguishing character, etc.) to help provide users a quick and identifiable short hand method for finding and assessing items of interest. Each item in the item database can be processed to determine in turn which symbols it can be associated with. The symbols are preferably chosen to be sufficiently disambiguated, so that a person with an eagle symbol will know that an item identified by the system as corresponding to a “bear” symbol will likely be less satisfying to the user than an item tagged with a crow symbol. Upside down or other rotations and perceptible alterations of known letters can be similarly used, since they are very recognizable and the relationship of two letters is immediately known to a user—i.e., if their symbol is an upside down “A” a wine that is marked as an upside down “F” is closer to their taste than a wine with an upside down “Y” and so on. Other alterations and distortions that are nonetheless easily recognizable and memorable can be used as well. This shorthand notation facilitates rapid review and comprehension by a user who then can shop for items without the benefit of an electronic assistant.

The above is one example of course, and the notion of groups (or genus/species) or other logical hierarchies can be exploited in other convenient visual or graphical to facilitate identification of items of interest. For example, acoustic or musical associations could also be exploited to categorize and differentiate products, with a user being assigned to a particular low note, or a particular high note, a particular music piece, or a particular genre of music, and so on. This may be useful for among other people—users who are visually impaired. The audio information can be associated with a QR code on the item and triggered based on identifying an item in a database of the present invention.

At step 230 results are presented to the participants regarding the overall scoring, rating of each item. An example of a preferred data screen for presenting such results with an event management website 135 or on a mobile device by a game computing routine is shown below and discussed in connection with FIGS. 4D, 4J and 4K. These results can be presented in a sequence based on a score, or, preferably, in a same sequence as that used for the sampling. This provides an opportunity to explore and investigate the character of each item among the participants without knowledge of the final results. Generally speaking if the sequence is done based on overall winners, losers, etc. the discussion portion is more focused on the results rather than on specifics of each entry. The data output can take any desired textual or graphical form. In some instances it may be desirable to allow item vendors to present promotional materials during the event, so that as each item is presented and rated, various forms of background information are presented for the benefit of the participants. This can be displayed along with the results as seen, for example in FIG. 4D discussed further below.

Then at step 235 in FIG. 2 results are presented regarding the characteristics of the participants as explained above for step 220. An example of a preferred output for this step is also shown in FIG. 4D. This aspect of the event can also be highly entertaining as inevitably surprises and insights are gleaned by the participants from the ratings behavior of their fellow participants. Rewards/booby prizes can be then be meted out as this time as well, for example to the participants who meet the criteria noted above, and/or who brought the highest rated wine, or the worse rated wine, etc. etc. Individuals who were best predictors of their significant others, experts, and the group can also be recognized.

During step 240 the various vendors 140 are preferably allowed to present feedback and incentives to the participants. As noted earlier, the event data may be collected dynamically or collectively at the end of the event, depending on the particular application. The vendors 140 may or may not have access to the tabulation results, or any other prediction data provided by the participants beyond bare ratings for the items. Again, the extent and scope of the data to be shared is preferably left to the discretion of the event manager and the individual participants.

The feedback and incentives can take any number of forms. It may be as simple as generic gift certificates for particular types of wine (or for whatever item was being sampled) or other accompanying products (cheese, chocolate or other gourmet foods).

Coupons can also be distributed to the participants, either electronically or in hard copy form by regular mail. The coupons can be correlated to a participant's residence or place of work, so that they are usable only within certain establishments. These establishments, in turn can thus coordinate with wine growers, vendors, etc. to target particular individuals within a certain radius of their stores.

The main wine vendors could further track the participants' preferences, and then use a conventional map mash-up to further educate and point out the location of items of interest based on the results of the event. For example, a vendor could track a user's location and inform him/her that a merchant (or vineyard, or restaurant, or bar) at a particular location in their vicinity carried one or more wine types determined to be of interest to the participant based on the sampling event (and similar prior events). By providing this information immediately in conjunction with the occurrence of the event the vendors can capitalize on the participants' interest and afford them an easy opportunity to satisfy their wishes.

Other item related information could also be passed down to the participants, such as the history, production or marketing details of the vineyard in question for wines which they found attractive. Predictions and recommendations for other wines could be made as well, using standard corroborative filtering techniques.

It is expected that vendors 140 and other interested entities will have access to complete ratings data, including time stamping of entries, participant profiles, venue profiles, etc. Based on this data the present invention contemplates that an supplemental form of normalized rating can be stored in a ratings database as well, to account for different types of distortions or bias that may affect user ratings, and which are determined by the game routines. Nonetheless it is further expected that vendors and other marketing entities will design, create and maintain their own version of ratings that they will employ for their own purposes based on their own modeling, rating treatment, etc. that they determine is most useful, accurate or relevant to their applications.

Accordingly, a series of wine related coupons could be generated and customized for each participant, and downloaded automatically into their data collection tool 130, another electronic account, or under control of accounts through event management website 135. Again these are preferably used in establishments which have a relationship with the wine vendor. The coupons may be accessed directly from the participant's data collection tool 130 or another computing device, and thus easily redeemed (i.e. by referencing an identification number) from local merchants. In some applications the coupons could be triggered in response to detecting the user within a vicinity of a particular establishment that is promoting the item in question. In other embodiments a first participant (or a member of a social network) can ask to receive coupons for items rated (or likely to be rated) positively by a different participant, so that they can use such promotion as a gift for the second participant, or as part of another sampling event. Other examples will be apparent to those skilled in the art.

From a social networking perspective, the participants could be presented with additional information relating their ratings to other members within or outside of their social circles. For example a notification could be made to other members of their social group that the user was involved in a particular event. By educating them about other similarly minded persons the participants can again derive additional benefit and enjoyment from the sampling events. The other member friends can also use this information as a source of gifting or selection of items later for the participant. For instance, a member could be presented with a solicitation that states “Fred likes Wine A; do you want a coupon for this item”? The option to elect such inclusion can be made, for example, preferably using an interface screen such as shown in FIG. 4B or some other suitable means.

As noted below, vendors can mine the lists to see who are good candidates for invitations to wine tastings and other similar parties. Furthermore the vendors may be able to do more sophisticated data mining to detect more subtle correlations, such as whether there are any material ratings differences depending on a sequence in which two items are sampled, or if certain items tend to be rated higher when they incorporated into samplings with other particular items. For example, an item A may tend to receive a higher rating when it is sampled right after item B, instead of being sampled before item B. These types of correlations can be identified used, in fact, to develop preferred “sequences” of wine tastings for those persons interested in optimizing an enjoyment of a sampling event.

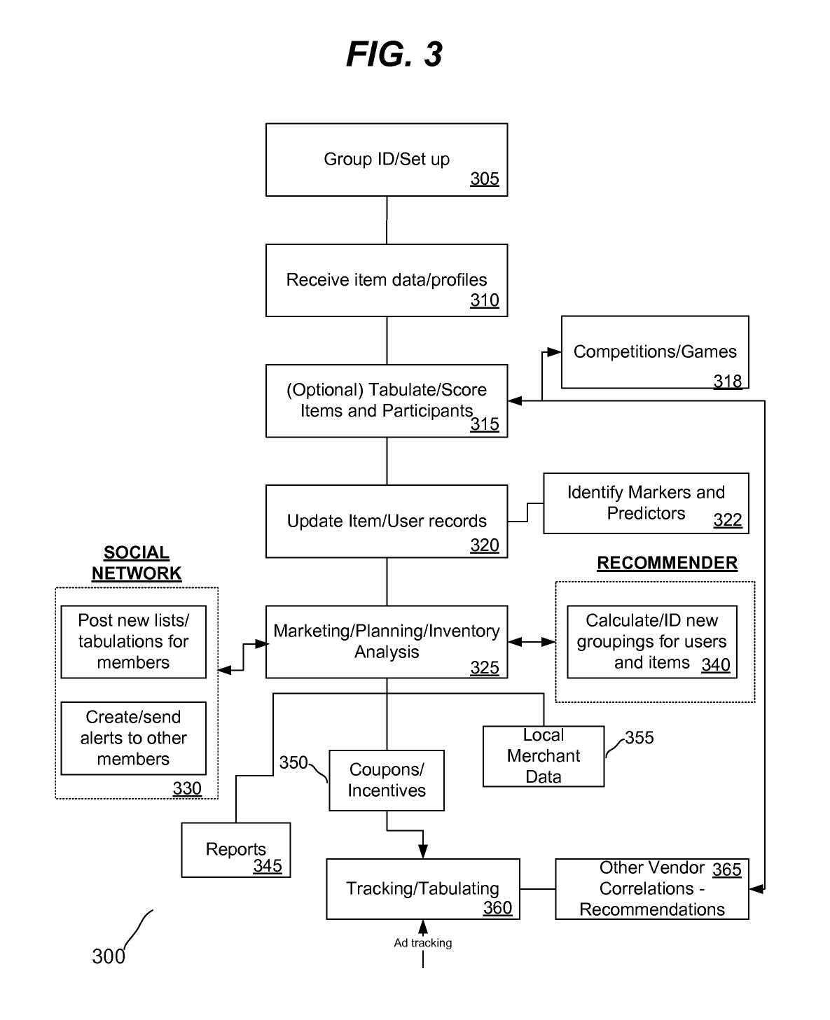

FIG. 3 illustrates the main components and operations used in a preferred back end process of the invention for compiling and updating ratings, users, etc. at respective e-commerce sites and other vendor facilities. This back end process is preferably implemented as one or more software routines executing on a variety of servers at event management website 135, or at other computing systems controlled by the various respective entities.

At step 305 event management website 135, or a vendor computing system (not shown) provides basic set up information for the event, such as by assigning an event ID, a group ID, or similar identifier. This identifier could include a list of the items, the participants, the location of the event, and other similar reference data.

In the case of a prepared or packaged kit, event management website 135 or the vendor (or some other entity) is responsible for compiling an appropriate set of items, which may be associated with a kit identifier. Website 135 can include programmed logic for this task; alternatively the vendors and other similarly situated entities can design the kits based on their particular marketing and research needs.

For example, a wine vendor may want to see what the public's reaction to various formulations or mixes of the same type of grape, say Cabernet, Merlot, Pinot Noir, Chardonnay, etc. The kit items would thus be constituted of multiple variants from the same grower/vendor. The kits could be supplied directly to event hosts, therefore, or to website 135 for distribution through managed events.

The ratings data received from the event could then be used by vendors to determine optimal blends for production and planning. In other instances a vendor may want to know how their product stacks up competitively against other selected products from unrelated third parties. The kits would then allow such vendors to reach out and determine the competitiveness of their product in a real-world environment. The composition of the item set in the kit, therefore, can be tailored as desired to provide meaningful experimental feedback data. The kits may include other complementary products, of course, which may designed to optimize the enjoyment of the product in question, for example, cheese, crackers, bread, nuts, fruit, etc. in the case of wine. The value of website 135 as an intermediary is thus potentially quite useful as the manager of such system can pick and choose from different vendors, and create customized kits as needed by individual events.

During step 310 the item data and user profile data is uploaded. The items are correlated as necessary with a database of items (not shown) for purposes of accurate record keeping. When the item is unknown, or new, the back end process 300 can create a new record as needed to begin the compilation process. Again in a kit implementation the data is already pre-stored.

Similarly the profile data for the users is recorded and maintained for the event as well. As alluded to above appropriate privacy measures can be implemented to assure the anonymity of the users.

In embodiments where website 135 or the vendor is conducting scoring, tabulating, etc., this is done by any conventional means as shown in step 315 in accordance with the guidelines noted above. Alternatively in implementations where the data collection devices 130 contain such functionality, the already tabulated data is uploaded to the back end process. It will be apparent that the tabulation of the event data could be done partially at both locations to share the burden and so as to integrate other data from sources unavailable from one or other systems. For example a website 135 or vendor back end routine may have access to data from other sources through contractual relationships that are not available to a typical end user of a data collection device 130. The back end process may also have access to more powerful data computation and presentation tools which can be used to enhance the feedback provided to the event participants.

If a competition or game is implicated as part of the event, the website 135 (or vendor) accounts for and determines whether any of the participants are entitled to prizes and the like at step 318. Again the format and prizes will vary according to the particular application. As noted earlier one type of award may hinge on the ability of participants to guess the ratings previously provided by known experts.

At step 320 the item and user records are updated in a database (not shown) based on the scores and other attributes provided to the items, and the ratings, predictions and other data provided by the participants. Again the amount and types of data to be collected and stored will be a function of the articles in question and the particular system to be implemented. Profiles for each user and item are also calculated and provided as well, as noted herein, based on a set of taste models. The taste models are developed as explained below to help better classify and differentiate users and items more easily, and with simpler designations, tags or labels. Each item and user is therefore associated with at least one and perhaps more taste model.

One or more calculations can be performed at step 322 to identify markers and predictors. These correspond to individuals among the participants who have distinguished themselves as reporting scores for items which tend to track the mean, median or other statistical parameter of the event group, a reference set of tasters, a larger population group, etc. In other words these persons are singled out for their predictive prowess as it were because their tastes are found to accurately mirror/predict the ratings of others. These individuals may be targeted/solicited for inclusion in focus groups and other events sponsored by vendors to help rate and identify new products. Other offers and incentives may be presented to such individuals to glean their insights.

Other tabulations gleaned from operations associated with step 225 (FIG. 2) and discussed above can also be compiled. For example, a website 135 (or vendor or other entity) may want to compile records on couples who tend to have similar tastes, or high accuracy ratings in terms of predicting each other's tastes, deviations or trends observed in ratings during events, or between certain venues, and so on.

The information obtained from the item ratings and scores can also be used at step 325 for marketing, planning and inventory analysis routines. For example, if a particular item is found to be particularly appealing to a particular demographic profile, this information can be provided and used in a targeted marketing campaign so that the selection of individuals receiving such promotions are likely to respond favorably. Other uses for this data will be apparent to those skilled in the art.

Similarly if a particular item is found to be very popular this fact can be used to identify potential inventory shortfalls, production changes, etc. Conversely an item that is not found to be desirable can be deemphasized as needed in favor of better performers. This type of analysis, of course, is most useful early on in the introduction cycle of a new product since sales and adoption rate data may be incomplete. Again the collection of this data by website 135 places it in a unique position to provide valuable insights to item vendors and distributors.

Website 135 and/or vendor(s) may then use the event data, including tabulation data, to generate reports 345, coupons/incentives 350, and feedback to local merchants 355. The reports may take any number of forms suitable for relating the general parameters of the event and the results thereof. Again, as noted above, in the context of an entertainment event the report may include text, charts, figures and other graphical data that communicates the scores of the items, scores of the participants, item-item correlations, and participant correlations among other parameters.

In some instances the reports may take the form of ongoing alerts to the participants, informing them immediately when special offers are available on items which they rated favorably at the event, or for items determined to be likely of interest. These alerts may be geographically targeted as well, and be correlated to the participant's physical location, so that, for example, an alert for item A only appears when the user is in one location, while an alert for item B would appear when the user is in a separate location. The participants can elect to subscribe to such alerts on an item by item basis or any other appropriate level of control.

The reports may also inform participants of other complementary products they are likely to enjoy as a result of their scoring on the event items. Coupons/incentives 350 may also take a variety of forms depending on the implementation. As noted above the coupons may be in paper or electronic form, and may be delivered by regular mail or electronically to the participants and other targeted members of the public. A coupon preferably is in electronic form suitable for delivery to the participant's computing device (including data collection device 130 in some instances) and will be correlated (or redeemable conditionally) in some fashion with a merchant with whom the vendor has a favorable relationship, and/or a merchant this is geographically located proximate to the event site, the domiciles of the respective participants, or the residences of other targeted members of the public.

The location of the participant can be determined by reference to GPS data, cell tower data, packet delay data, etc., and other mechanisms known in the art. Additional geographic mapping data can be provided along with an electronic coupon so that when it is delivered to the participant's data collection device 130, an electronic map can be presented to the user indicating the location of the nearest store/merchant carrying the item(s) in question to facilitate and encourage purchases of the products from preferred merchants. The coupons can be for items of the same type as those rated in the event, or they can of course be simply other items.

Alternatively an email or other electronic message can include embedded electronic links and other content related to an online vendor of the items. So, for example, a participant may receive an email with links informing them of a number of online wine vendors who have the best price available for one or more wines rated highly by (or predicted to be desirable for) the participant. The links can be generated by an electronic based mass marketing system (not shown) that automatically executes targeted searches based on the wine in question (i.e., a 2004 Stag's Leap Chardonnay) at competitive shopping sites (i.e., such as Google's shopping site) and delivers results directly to the participant. This type of targeted marketing allows for higher conversions and monetization of such advertisements. By partnering with direct to consumer wine retail websites, a portion of such leads generated by the present invention can be captured in the form of commissions. In other variants a participant may receive a coupon for participation in another sampling event, in which they are given a discount for attendance, or for an item to be sampled.

Therefore at step 360 the back end process (at website 135 or at a vendor site) preferably performs tracking and tabulating of the redemptions made by participants and other persons for the coupon products in question. This monitoring of the performance of the coupons/incentives allows for further refinement, targeting and follow up with the appropriate consumer profile. For example, the redemption rate for coupons of varying values, for particular local merchants, for particular products, etc., may be compiled to determine the efficacy of the promotions. Other events which can be tracked, of course, include the participant selections of advertising presented for such products, as referred to above in FIG. 2 reference numeral 240.

As shown at 365 website 135 and/or the vendor may also have their own database for tracking item and participant correlations, and it may include customized data items based on the vendors' own modeling or parameters. This may be done using any conventional collaborative, corroborative, or other data filtering techniques known in the art. This allows website 135 and/or the vendors, for example, to identify clusters of participants with similar tastes, items which tend to be correlated well with other items, etc.

So for example, after reviewing event data and noting that person A preferred product X, the system may note that person B, who is well correlated to A, has not tried X at this time. This analysis (other techniques are also possible of course) can help to provide predictions and recommendations to person B (and others similarly situated) by website 135 and/or the vendor for more effective targeting. Similarly the item ratings can be updated to determine item-to-item correlations. For example, the system may note that persons who rated X highly also rated Y (and other products) highly, and so forth. This information can be used, again, for marketing, advertising and other promotional purposes. Thus, when person A expresses an interest in product X, website 135 and/or the vendor can generate a prediction and related recommendation for A to inform him/her of the existence of Y (and others as appropriate).

Again, as noted, the recommendations can take the form of very specific geographic targeted alerts, messages, so that when A is in a particular store (brick and mortar or virtual) the system can detect his/her location, and notify A (through a PDA/cell phone browser, or Internet interface) that product Y is available (again, perhaps with an accompanying electronic coupon) within such within such establishment (including websites of course). Thus the invention correlates user location with items/products in which they have expressed an interest (or items which are predicted for them to be of interest). It then helps them to easily identify proximate sources of the same, and particularly from establishments who are coordinated with website 135 and/or the vendor to effectively market/sell targeted products. In some implementations a data collection device can be set to an auto-item discovery mode, so that when the participant is within an establishment, the device can inform the person on whether there are desirable items at such location. This creates an end-to-end virtual marketing/distribution chain that is optimized for the user dynamically on a location and product basis.

At 355 the local merchants are provided with excerpts, as desired, of the tabulated ratings and other event data. This assists such entities in performing their own localized target marketing to individuals located in close proximity to their establishments. This information can also assist them in determining their own planning and inventory management.

The event data can also be provided to generic product recommender systems at step 340. For example, other websites or other set of vendors may be interested in maintaining a database of user tastes, user clusterings, item correlations, etc. for their own respective collaborative/corroborative filtering system. As noted earlier, a number of third party sites are known to provide suggestions and ideas for wines, and thus such entities can exploit the data collections maintained by embodiments of the present invention. These entities can maintain their own separate user clusterings, item correlations, etc., or they can simply use the already tabulated data from the vendor as created at 365.

In some embodiments the activities of the participants, or their results or prizes, can be communicated to and recorded at one or more social networking sites as shown at 330. For example a social networking site member may be a participant in one of the events noted herein. This fact, along with (all or some portion of) the person's preferences as expressed in the event, may be communicated and maintained either at such member's personal site, as part of a personal data feed to other selected members, or at other social groups maintained at such site. For instance the social networking site may maintain a wine group that tracks ratings and interests for its members. The tabulated data from the member (and other members from other events) can be used to compile one or more lists of brand items preferred by such site members.

Again the inclusion of such data at the social networking site would be an option available to the member at his/her own discretion. The participant may elect for the event data to be selectively disseminated to preferred members of course, including only persons within a certain select circles or designated degrees of friendship/kinship. In some cases it may be possible to anonymize the data from participating members so that only the raw ratings are provided at step 330 for compiling of the community's overall tastes.

It will be understood by those skilled in the art that the above is merely an example and that countless variations can be implemented in accordance with the present teachings. A number of other conventional steps that would be included in a commercial application have been omitted, as well, to better emphasize the present teachings.

The features, functionality and appearance of a preferred website 135 (or a mobile app that is separate from or integrated with such site) configured in accordance with teachings of the present invention is shown in FIGS. 4A to 4K. These figures illustrate examples of interfaces and functions performed in a preferred embodiment of the invention in which the items consist of wine articles. In FIG. 4A, a preferred embodiment of a wine party event setup interface 410 is depicted. This screen is primarily responsible for collecting the setup information discussed above in connection with FIGS. 2 and 3, including steps 205-215.

The entry fields and options are self-explanatory but are explained here further nonetheless. As seen in FIG. 4A, a party host can specify the date and time of an event, and the location. The party host can also specify what type of event is required (in this case a tasting of Cabernet related wines). The event ID and Kit ID are also shown for reference and administrative purposes. A participant response status is also conveniently displayed so that he host can determine an expected attendance and progress to date in collecting appropriate samples (when that option is elected).

The Event details 415 also highlight other options that can be elected. For example, a host can decide whether they are going to run/manage the event on their own, or if they are going to rely on wine party website 135 instead. In the former case the host can then also specify the nature and contents of media 112 to be used, so that it can be customized to their liking and requirements. Similarly the event host can specify that they are going to supply the items, or that the wine party site should supply the wine. In the latter case the host can elect for the items in the kit to be automatically compiled in accordance with the criteria noted above in step 215, i.e., to include wines in particular price ranges, for particular wineries, or even request a randomized option.

Furthermore the host can specify whether the event is to be a blind tasting or not. In those cases where website is to supply the items, an option can then be elected for the bottles to be shipped to the event host with blanking labels to obscure their origin. Alternatively if the host is to purchase the wines they can nonetheless request a set of masking labels from website 135. The masking labels can be prepared according to a host's specification, and include playful pictorial elements or other content such as images, funny graphics, the names of the samplers, etc. and can be printed and prepared by the host prior to the sampling event.

As noted above in step 220 the event host can specify what types of data are to be collected, including ratings, predictions, profiles, etc. as noted earlier. Another selectable option is whether or not the item suppliers are allowed to present short multimedia promotions during the event as discussed above. Furthermore the website 135 (or mobile app) can be instructed to conduct various forms of games, competitions within the guidelines addressed earlier. For presenting results (as discussed for step 230, 235) the system can be configured to present such information only to event participants, or to share it with other vendors and merchants.

The types of prizes, promotions, etc., can also be specified as noted to include coupons and other incentives. To optimize response rates the system can be directed further to send timely reminders to participants through different delivery channels. Similarly the system can include a “preview” option in which the overall selection/list of items is sent in compiled form to the participants to educate them in advance of the selections to be sampled at the event. As part of this preview, a list with labels, photos, etc. can be shared. Finally the host can also ask for suggestions on particular types of foods to accompany the tasting, and direct that such also be included as part of an event order.

All of the above options are modifiable directly within interface 410, and/or in more detailed form using a button/field 412. The latter merely presents an additional menu/screen (not shown) for collecting this data in any desired and conventional manner known in the art.

Within the interface are also further options for configuring the event. For example at button/field 411 an additional menu/screen (not shown) is implemented in conventional fashion for capturing the participant names, emails, and other desired profile information as noted above in step 210. Field 413 allows the event host to select among and pick the different types of sampling kits that can be used for the event as noted above. The host's account information, including contact and billing information, can be selected from field 414. A game wizard's predictions and recommendations for the sampling event are also shown as selectable by an option field 416. The predictions and recommendations can then be accessed and adjusted by routines associated with FIG. 4M discussed below. Again, these are but examples of the kinds of fields/data that can be collected within an event set up interface, and it is expected that commercial embodiments will vary visually and functionally significantly from this and from each other.

In FIG. 4B, a preferred embodiment of a wine party event hookup interface 420 is depicted. This screen is primarily responsible for permitting individual participants to connect to specific events. Thus, each participant preferably has an account which permits access to different events which the participant is invited to. A participant would be given an access code or other URL for accessing the event associated with entry screen shown in FIG. 4B. Fields 421 provide the identifying information for the event. A participant's mobile device can be set to an auto-discovery mode as well, in which they are notified of events in a geographical vicinity to permit them to find such functions easily.

At field 422 a participant can see the results (final or in progress) for the event, including winning wines, winning participants, and the like. In portion 423 of the interface a participant can view his/her prizes, individualized coupons, targeted promotional materials, etc. Other marketing information, ads and similar content can also be presented.

Profile information can be seen/altered at portion 424 of the interface, including demographic data, residence/work addresses, interests, affiliated account names at other sites (such as social networking sites), etc. This allows for sharing and publishing of the event data at the participant's discretion. An RSS feed can also be provided for interface 420 for the benefit of broadcasting a participant's results.

Lastly, portion 425 of the interface includes some activatable button or URL to cause the participant to be connected to the event in question. By connecting to the event the participant can then participate in the rating of items, review of contents, collection of promotional materials, etc.

Next in FIGS. 4C, 4F and 4G a preferred embodiment of a ratings capture interface 430 is shown for the invention. Again the entry screen is adapted to capture ratings by individual in a region 431, including the parameters discussed above in connection with FIGS. 2, 3, such as item ratings, predictions for other individuals, predictions for expert ratings, matching of the item to an actual label (showing one or more bottle/labels and asking the person to pick one matching the item) and other descriptors.

In one optional variant, a rating “wizard” is included as part of the game to increase enjoyment and participation. The Wizard is implemented by the game routines as an avatar and can perform a number of functions during game, including giving feedback on the opinion of the prediction given by the participant for their partner, the group, etc. This can be done either by an interactive visual expression that denotes agreement, disagreement, approval, disapproval, etc. The Wizard can also optionally expressly tell the user the Wizard's prediction for group, partner, etc. Preferably this data is provided after the user has provided their own rating to avoid influencing the user's rating. While the avatar is shown in the form of a wizard figure it will be understood that any number of different variants would be acceptable for this purpose.

As a source of ratings for the partner and the group, the wizard can use a database of prior ratings by the participant, the partner, prior ratings for the item in question (see database 605 for example below), a predicted score for the participant based on his/her correlation to another user in the database, the participant's correlation to another user in the group participating in the event, the partner's profile/taste model, the absolute/relative time of the item sampling compared to a start time or sampling of another item, and so on. Gender, age and other factors can be considered. In the absence of explicit ratings for the participants or items it will be understood that estimates for this data can be generated in any number of different ways. Because the Wizard knows the actual identity of the item, and the participants, the electronic software avatar can derive this data accurately and automatically before or during game time. An initial set of predicted Wizard ratings, both for each individual and for the entire group can be predicted and determined as a benchmark or baseline for the event. This data can be accessed before and after the event within an interface 480 seen in FIG. 4K. In this figure it can be also that the Wizard's “results” or predictions for the event can be seen in a post-mortem process as well for the group's benefit. The Wizard can be compared with other participants to see a relative performance.

In some embodiments the Wizard's predictions—either individually or in aggregate—can be implemented as a game planning tool and accessed by the host ahead of time as shown in FIG. 4A, box 416. To assist the host in configuring the event, the Wizard tool may in addition generate a predicted “fun” or enjoyment factor for an entire sampling event as seen in FIG. 4M based on the aggregated individual and item ratings along with other data in areas of an interface 485.

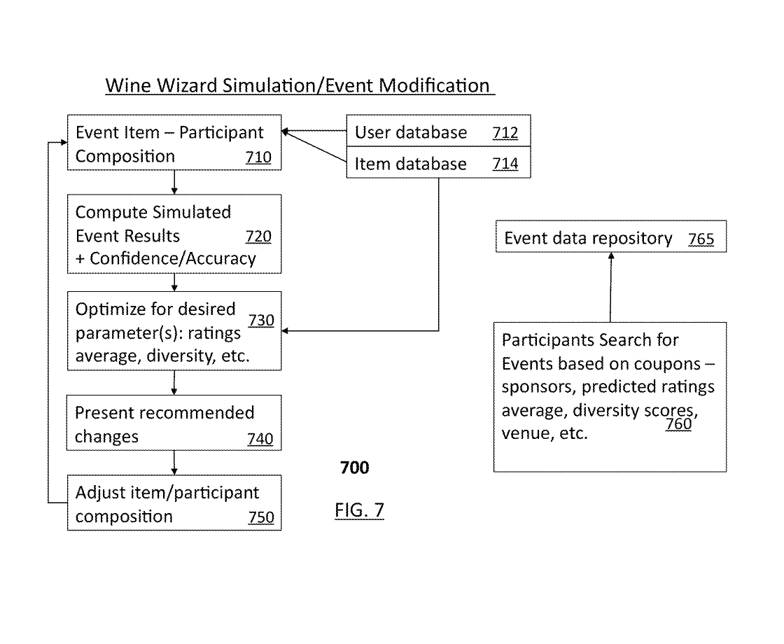

The Wizard can similarly simulate and derive all the individual results as well. This feature allows the host to adjust, tweak or modify the composition of the items or the participants. For example the host may determine that the inclusion of a different item or participant will alter the sampling event dynamics and result in a different event dynamic. It may be desirable to alter group diversity in scoring, partner diversity, gender diversity and wine diversity as seen in FIG. 4M. The data concerning the expected differential in actual/predicted scores, for example, represents a “surprise” factor for the event. In other words, the wizard can predict how well the participants are likely to predict, because certain wines may give an illusion to the user of rating higher or lower with other participants. The operation of the Wizard is also shown in FIG. 7, and can be implemented by any number of computer routines.

Returning to FIG. 4K, while the Wizard cannot change his ratings during an event after they have been provided, it can adjust the initial ratings dynamically based on feedback gleaned during the game. For example the software logic for the wizard may consider an observed and measured deviation of an actual ratings seen during the sampling event from participants from a predicted rating. In other words the system can determine if it is consistently overestimating or underestimating ratings, and the reason why. A particular sampling event may consist of a group of persons who are more inclined to rate items higher or lower. In some instances it may be the item in question does not meet the qualities of a typical item of that identity, for reasons related to aging, defects, inconsistent production, etc.

In other instances the electronic agent or wizard can track ratings “creep” which can arise during the event and can be caused by a variety of factors. Participants are influenced by seeing others' ratings, hearing comments, and through similar interactions. Furthermore as wine tastings proceed, and depending on the amount of item that is sampled, the inventor has found that the effect of the product on raters is to cause an increased mood state, which, in turn, results in higher ratings. This is a natural consequence of any consumption of certain products.

Accordingly wines rated later in the process may artificially receive higher scores simply by virtue of the order or time in which they are sampled. For this reason both the position of the item being sampled in sequence, as well as the time (in the form of a timestamp), can be recorded as well in a master database.

Based on the results of prior games and ratings, statistical analyses can determine a normalization factor or constant that must be accounted for in ratings provided during a sampling event. The game wizard can account and model for this, as can the general ratings compilation modules described herein. That is, the routines can track the overall ratings behavior of the participants and if a similar rating pattern to prior games appears to be developing (based on measuring ratings changes over time) there can an adjustment of the ratings scores. These adjusted ratings scores can be stored in addition to the non-adjusted ratings within a database 605, and optionally presented for the participants' benefit as well. The adjusted ratings, accounting for time, sequence, etc. can also be used by vendors, merchants, recommenders, etc. as another perspective on the data set. Because the time corrected ratings are adjusted to account for these observed event biases they may in fact be more useful for marketing, recommendations, etc. Skilled artisans will appreciate that other event bias distortions can be accounted for and corrected as well, including venue bias, time of day bias, and other measurable and controllable parameters.

It will be understood by those skilled in the art that the data interface 430 could be implemented in a single screen, or multiple screens depending on the type of options selected by the host for the game format. Suggestions for descriptors can be given to the raters to facilitate data entry, such as shown in FIGS. 6A-6C. As noted earlier in the preferred embodiment the screen resets itself after each person makes an entry and sequences to the next individual to allow for anonymous ratings collecting. An optional individualized and assigned code (not shown) can be used to access a particular user's profile, ratings, etc.

A second portion of the ratings interface is shown in FIG. 4F. When this option is enabled for a blind tasting event the system also presents a list of items in field 432, including the one actually rated by the user, and requests that the user identify which one they just sampled. The list is preferably randomized and includes at most 4 or 5 items to make it more challenging for users. Actual label information, as captured by the host, or from content provided by an online vendor, supplier, etc., can be used as well. Price information can also be optionally presented to the user. In addition other characterization data (not shown) can be presented as well, including descriptors of the flavor, color, texture, etc., as hints to the user to help them select the appropriate choice. This discovery challenge data is preferably presented after the user has already presented a rating, to avoid influencing their opinion and scoring. Soliciting this data provides an additional game element by which participants are allowed to guess, speculate and discover an appropriate match for the item they sampled.

The user can optionally be requested to provide data at field 433 to indicate if they think the item sampled is the one that they brought to the event. System logic can control such inputs to ensure that only one “yes” response is provided.

FIGS. 4G-4H show another variant of a wine discovery game aspect, which can be implemented alone or in conjunction with the in-game or ratings mode discovery aspect shown in FIG. 4F. In FIG. 4G, after the users have provided ratings for each item, or for all items, they can be prompted to guess or match each of their ratings in a first phase to the actual set of items in a portion 434 of the interface. This gives participants an early clue and view of the identity of the products that were sampled. The participants' prediction data can be put in the form of numerical identifications, i.e., item #1 in portion 435 can be matched in a box 436. Or, alternatively each rated item can be highlighted in sequence on the left in portion 434 with the participant then touching one of the labels on the right to correspond to the rating. Other formats will be apparent to skilled artisans.

FIG. 4H shows a second phase of the wine discovery game aspect, in which more information is revealed to the participants about the items as shown in FIG. 4G. As seen there, additional information in field 437 is given regarding price, characterizations, etc. of the items as clues or hints to the participants. The raters/gamers can then change their matching selections as presented in phase 1 (FIG. 4F) or they can maintain or stick with their original choice. In the example show the rater has switched their opinion, as seen, of items #1 and #2. The data for the descriptors (fruity, floral, spicy, wood, nutty, sweetness level, etc.) can be extracted from any convenient source, including the vendor, online review sites, social networking comments (public or from friends of the raters) and so on. In yet another variant, the price information may be masked for the items, and the participants asked to pick a price from the selections in 435, and match it to a sampled item. As seen here, for example, the participant has predicted that the price of item 1 is believed to be $9.99. This portion of the game may be isolated and presented at the end of the ratings process after the identity of the items has been revealed to reduce confounding of the results (i.e., mixing predictions of identity of items with their price). Other descriptive data, clues, and variants of the wine discovery game will be apparent from the present teachings.

In FIG. 4D a preferred embodiment of a wine results interface 440 is shown. In region 441 of the display it can be seen that scoring data is compiled and presented for the participant's benefit, including an overall ratings score, statistical information, relative placement of the item compared to others, predicted data, etc. As noted above, in addition to the actual ratings, the system can generate and display time adjusted ratings to take into account ratings creep. Comparisons to other events, groups of raters, or an entire database of ratings can also be displayed for the participant's enjoyment, as people like to compare themselves and see their perspectives relative to others. It should be noted that all or some portions of the results interface may be presented to individual participant devices 130. In some cases it may be useful to depict the ratings data in graphical format.

At portion 442 of the interface the vendor of the item is given a canvas or display region in which to present multimedia information concerning the item, such as text, graphics, images, video, audio, etc., conveying background information on the items in question. Awards and other related data can also be presented for the viewing audience's pleasure. This feature allows the vendors to showcase their wines and promote themselves in short, succinct snippets. In area 443 of the interface the participant can see predictions and recommendations for other wines/items based on correlations to other items. Negative correlations can also be accommodated if desired. Thus the participants can be given specific tailored suggestions on items that they are likely to enjoy given a positive/negative rating for a particular wine.

Finally, in area 444 the interface is adapted to allow participants to opt in to receive additional promotional materials, discounts, coupons, etc. for the item in question. For individual devices 130 this may cause the promotional data to be downloaded directly to the same, or in other cases it may be sent in email form. While not shown in interface 440 it will be apparent that other areas of the display could be modified to provide more comprehensive results comparing the entire item set, the entire set of scores for participants, etc.

In some embodiments, as seen in FIG. 4J, in addition to cycling through every item sampled to review its results, interface 440 can also be configure to sequence through and present game related data for each participant in the group as well. This increases the enjoyment and interaction of participants, as everyone's ratings, predictions, and discovery accuracy scores can be presented for the group's review. For example, the data captured in FIGS. 4A-4H can be processed, so that each individuals' accuracy in ratings, predictions for partner, predictions for group, predictions for expert, predictions for the group,

FIG. 4E shows a preferred embodiment of a vendor interface 450 as could be employed in embodiments of the present invention. This data capture/presentation screen permits vendors to manage and coordinate multiple events involving their products. Thus, for each vendor, a software tool is provided at 451 to manage specific events. While the specific format of this event manager is not shown, it could take the form of FIG. 4A, modified of course by any vendor's requirements.

At entry area 452, a software routine is adapted to allow the vendor to propose/construct event kits suitable for use at the item sampling events. For example, the vendor may provide a list of wines of a particular vineyard and grape type which they want website 135 to present as an event kit. Alternatively this feature can be used by the vendors to vend specific kits independently with stock items from the event management website 135. For example it may be desirable to re-package the vendor's items into suitable form (standardized bottles, containers, labels, etc.) that is consistent with a preferred appearance for the kits.

For the distributor relationship manager function shown at 453, a routine and related databases are adapted to permit the vendor to identify key relationships with distributors, and to set up prioritized designations of entities to be associated with participants. For example, as noted above a vendor may designate a particular set of distributors to be used in events associated with a particular zip code. The vendor can also specifically identify other websites (including social networking sites for example) which are permitted to share or access data for particular events, products and/or participants. Other examples will be apparent to those skilled in the art.

An additional software option for managing competitions, prizes, etc, is provided for at functional selection 454. This allows a vendor to set up various games in accordance with the discussion above in connection with step 318 and related procedures (FIG. 3). Similarly, an option 455 permits the vendor to manage product coupons and incentives, such as designating which items are to be associated with coupons, the amount of such coupons, the locales of such coupons, the demographic profiles of target participants, etc. Again this information would be stored in a conventional database using well-known software and query techniques.

At option 456 the vendor is permitted to see a complete list of all events associated with their products. Again, any form of presentation and format known in the art would be acceptable for this purpose. Preferably the vendor can see all upcoming events sorted by date, by item, by participants, by demographic groups, etc.

Option 457 invokes a routine that displays product/participant rating histories. This, again, can be supported using any number of conventional software programs and associated databases. As noted earlier, time adjusted ratings, or other event related distortions (venue, group composition, etc.) can also be maintained and used for marketing and sales purposes. This feature preferably allows a vendor to sort and tabulate products by identifier, by ratings value, etc., and to identify participants who rank their products high (or low) as well. The performance rating of an item can also be tracked over time to see if it is changing. Similar studies can be made of individuals, as well, to see if their interest is waxing or waning in the vendor's products. All of this data can be used to help develop and focus marketing/advertising campaigns and literature.

At option 458 the vendor can manage and view product recommendation data, again using conventional software and databases adapted for such purpose. The system preferably allows a vendor to exploit both collaborative filtering (person to person) and corroborative filtering (item to item) techniques to identify trends and correlations between persons and items. The vendor can also, if desired, explicitly bias the system so that a first item is correlated to a second item for promotional purposes. Other correlation adjustments can be made as necessary to promote the goals and targets of the vendor, such as by increasing or decreasing the probability of certain predictions, recommendations, etc. Correlations between unrelated types of items can also be specified, for example, so that a certain wine is recommended with a certain appetizer, dessert, etc. By developing/accessing user correlations the vendor can also begin to compile a library of individual tastes for their products and identify candidate persons for the types of functions noted above in connection with procedure 322 (FIG. 3).

Using option 459 a vendor can manage and view product promotional content, including snippets of multimedia data appropriate for presentation within a user interface at device 130 as noted earlier. The vendor can also upload and edit content using conventional routines to format the same into correct form for different types of participant computing platforms. The promotional content preferably should consist of short audiovisual presentations describing the history/background of the product, the vendor, etc., or in the case of wine, information on the locale where the grapes are grown, the harvesting and manufacturing processes, quality control parameters, awards and other related advertising data. Again in a sampling event context it is preferable that the promos be of the same length, and not be too long so as to bore participants. The amount of time will vary according to product of course, but in most cases a few minutes or less may be appropriate for the item in question.

The vendor is also given an option at 460 to manage their generic account information, which may include passwords, billing information, addresses and other administrative data.

Again while illustrative data entry fields and content are depicted in FIGS. 4A-4G it will be understood by those skilled in the art that other data can be captured and presented, and other mechanisms can be employed to solicit the required information. The final form of such interfaces are expected to vary widely in accordance with the application and the nature of the items. FIGS. 4K and 4M show the kind of results that can be generated for an optional game wizard as noted earlier. The Wizard's predictions and performance can be compared to actual group averages for the items, as well as scoring for individual contestant scores. Other forms of data can presented in interface 480 by the wizard agent logic. In FIG. 4M the host can see a complete simulation of an event based on the items and participants for an upcoming event. The Wizard can inform the host of the expected scores for the items, the participants, etc. to get a preview of the event. The host can then change items, participants, etc. to monitor any changes in expected ratings, outcomes, etc. in interface 485.

Again while specific examples of expected differentials and parameters are shown in FIG. 4M it is understood that other event parameters could be modeled, predicted and assessed ahead of time by the wizard processing logic for the host's benefit. The wizard game simulation logic could be run locally on the host's mobile device, or on a remote server, or any other conventional computing platform.

The operational logic of the wizard event simulation is shown in FIG. 7 as it may be implemented by a computing system. The event details, including venue, items and participants are defined and stored at step 710. The selection of these parameters can be done through any number of routes as noted above. For example, the host may define a venue, a time, a participant invite list, and a selection of wines in the case of a wine tasting event. A user database is also accessed at step 712 along with an item database 714 to identify prior ratings, preferences, venues and time behaviors etc., for these entities. At step 720 a simulation of the event's expected results, along with a confidence score is computed. These results, as noted earlier, can be presented to a host in an interface shown in FIG. 4M.

Based on these results a host (or other contributors to the event setup and configuration) can manually optimize, maximize or minimize various parameters to achieve some desired result for the event at step 730. In other instances the host can access an automated program to help with this step. For example, an event may be configured so that a maximum average rating will be solicited from a group of participants as a whole for a nominal item set. A simple change, such as a change in an a few items, or even a venue/timing, may be sufficient to bring about an increase for example. In other variants, an event can be configured to result in a large diversity of ratings, based on historical data gleaned from the participants' prior ratings, and ratings for the items as a whole across an entire domain of users of the system. Item sets can be selected so as to cause a large disparity between genders, age groups, and so on. Other forms of game configuration will be apparent to skilled artisans.

At step 740 the system can present recommended changes in an item set, a participant set, a venue, etc., to achieve the desired specified event result. This can take the form of a “what if” simulator therefore which allows a host to dynamically interchange or substitute elements to see predicted changes. After this the host can adjust and accept the altered final event composition data at step 750. The event invitation details can then be initiated in accordance with the modified participant, item, venue or timing data.

In some embodiments participants (prospective or actual) can also search against a database of events at step 760. Coupons, promotions or openings provided by vendors and/or hosts can be associated with sampling events. This query can help a user decide which events to attend, based on reviewing coupons, average predicted ratings, a venue, predicted diversity scores, other participant profiles, and any other measure computed by the prediction wizard routines. This function can assist users to find sampling events to their liking and maximize participant in upcoming events, as they can ask to join and be accepted for a particular event. At step 765 an event data repository can be further consulted to see if there are open positions for participants as well. For example, an event host may post a listing for an event in which a particular item, a particular participant profile, etc. is requested or required for attendance to fill out or complete an upcoming or proposed event.

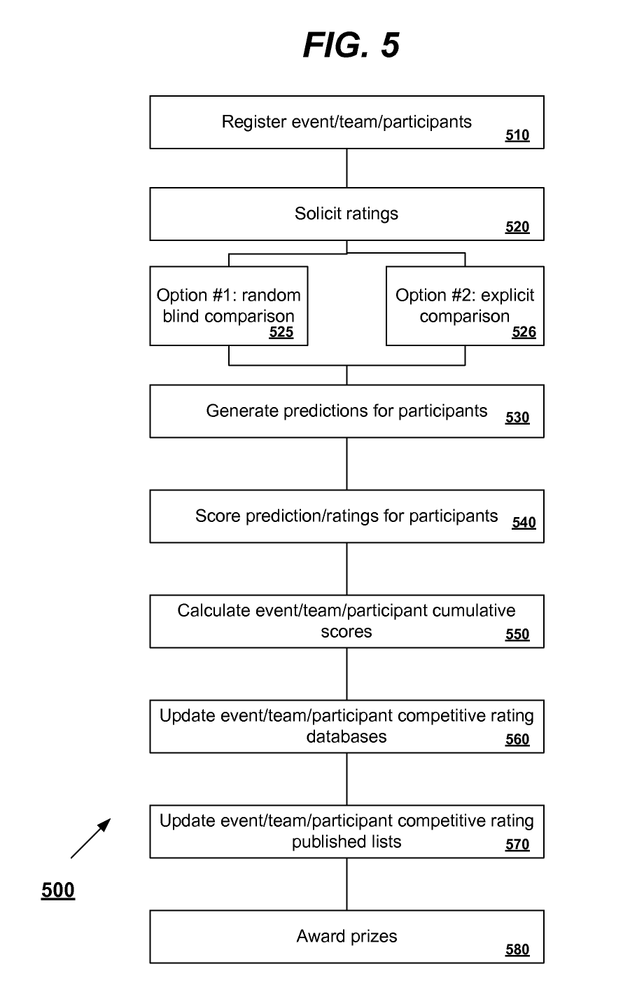

FIG. 5 illustrates a preferred process for conducting a competitive ratings game 500 as part of a gourmet item sampling event. This aspect of the invention allows participants to be evaluated and rewarded on an event/team basis for consistency and accuracy of their ratings data. From a high level perspective this feature allows participants to match their ratings against a prediction generated by a computerized scorer monitoring the event. Participants can then be rewarded based on how closely their ratings match the predictions made by the computerized scorer. The other prediction, ratings and game features described above in connection with FIGS. 4F-4M and FIGS. 6A-6F can be integrated and incorporated within the broader framework described in FIG. 5. Note that this technique can be used in other environments as well, and is not limited to the present embodiments.

In some instances it may be necessary to solicit explicit ratings from the participants in advance to develop a profile, as is done with conventional recommendation systems. This data can be collected in any desired fashion by reference to items already known to the system, so that appropriate correlations can be developed for the participant in question. Since the identity of the items to be sampled is known in advance, the invention can exploit this knowledge to pick ratings items based on known correlations. Thus, if item X is correlated with enough data to item Y, and X is to be sampled at the event, the invention can solicit ratings for item Y to assist with the later predictions for X.

It can be seen that the information for the participants/teams/event can also be used by the invention to set up and determine the items to be sampled at any particular event. In other words by knowing what wines the participants have previously rated, it is possible to determine a correlated set that is likely to be of interest to the group participants. In other cases it may be desirable to develop new correlations between items, so the invention can suggest combinations of items intended to better flesh out an available data set, and thus increase overall system prediction accuracy. Stated another way, the matrix of participant ratings/items can be augmented with creative inducements to the hosts and participants, which in the long run should result in increased satisfaction from improved predictions and recommendations for participants/users.

At step 510, the host/participants of an event can elect to register and be included in a competitive ratings game. Registration is preferably on an event basis, but it is also possible for other forms of collective scoring, such as on a team basis (where a team is made up of a group of n or more participants) or on an individual basis. These different forms of registration also permit different types of ratings to be presented in different respective lists on the website of FIGS. 4A-4E and/or in accordance with the process shown in FIG. 7 for public review and entertainment. It is expected that this feature will promote participation in embodiments of the invention as well by appealing to the competitive streak in some participants.

It is expected that the computerized scorer will simply take the form of the recommendation engine such as described above in connection with steps 340 and 457. Since most conventional recommender systems must generate a prediction for a person before generating a recommendation, this fact can be exploited for a gaming purpose as set out herein. Thus this aspect of the present invention allows participants to see and observe the inner operations of a recommender system from an entertainment perspective and thus glean insights into their own tastes as well.

At step 520, ratings for the items are solicited in the same manner as described above. As part of this process, the participants can be informed in advance of what protocol will be used for the computerized scorer to guess their ratings. For example the event may be set up so that the participants are only told that the computerized scorer will be generating predictions randomly for only some of the items, or for only a single item as shown in box 525. Alternatively the participants may be told in advance which items the computerized scorer will be making predictions for, as shown in box 526.

Both options may be useful in different types of applications. The usefulness of a random option lies in the fact that it is less likely to result in a ratings bias which may occur as a result of participants trying to “game” the system by providing artificial ratings designed to maximize their score. If participants do not know in advance which item is being considered for the ratings match competition, they are less likely to provide adulterated ratings. At step 530 the recommendations system (not shown) generates predictions for the participants in any conventional fashion, including by corroborative filtering, collaborative filtering, or some combination of the two. Other techniques known in the art can also be used. The prediction by the computerized scorer therefore is performed for one more of the items in the sample set used in the event.

After this step the predictions by the computerized scorer and the ratings provided by the participants are compared on an item by item basis at step 540. The scoring noted above for comparing participant scores can be used here as well, such as by summing the square roots of the differences of the squares, or if desired, some other form of mathematical analysis can be done. In the end, a table can be created (not shown) correlating the performance of each of the participants against the computerized scorer for each item so evaluated. This table can be stored in an array or any other convenient form for manipulation, storage, etc.

During step 550 an overall event/team score is determined. This can be as simple again as summing the cumulative differences noted in step 540. This event/team data can be presented to the participants as part of the other scoring items noted above in connection with FIGS. 4C and 4D.

Note that to allow for better metrics and benchmarks, the competitive aspect of the invention may be tied or restricted to specific game kits (described above) having a known composition of item samples. For example a standard set of Chardonnays from 10 particular wineries may be used. This will promote better comparisons and evaluation of data since the item sets are less variable and thus better characterized across larger sample sizes.

Another beneficial side effect of this aspect of the invention is that it is likely to induce participants to provide more accurate and consistent scores for the items than prior art schemes, since the participant will know that such input will increase the odds that the computerized scorer will generate an accurate prediction for such person, and thus improve an overall team score. This symbiotic nuance makes the participant into a more of a cooperator with the system, in the sense that they will want their tastes to be discernible and understandable to the recommendation system. Thus it is expected that this positive inducement will result in more accurate ratings data being provided by the participants. Again this particular aspect of the invention is likely to have benefit in other domains.

At step 560 a competitive ratings database (not shown) is updated with the new scores from the event/team/participants in question. This database can mined as well for targeting marketing based on the likelihood that team members, or event participants, are likely to be associated with each other and have similar tastes in other products. For example it may be useful to treat the entire members of a team or an event as a single entity, and construct ratings matrices for such collections of individuals. This would allow predictions and recommendations to be served on higher order groupings—i.e. entities as opposed to individuals. Thus recommendations can be made on a team by team basis based on collective ratings. At the end of the event follow-ups can be made with targeted marketing and recommendations to such individuals and teams in the manner noted above for FIG. 3.

The individual/event/team ratings can be published on the aforementioned website in any convenient tabulated form as shown at step 570. For example, it might be desirable to list the highest performing individuals in aggregate, and then broken down according to wine type, and/or by geographic region. The same strategy could be used for events and collections of participants (teams) who elect to compete.

If desired, optional prizes could be awarded on a periodic basis at step 580, such as every week, every month, etc. Again the prizes may take any number of convenient forms, including coupons/discounts for the items in question or some other consideration. In some cases it may be useful to keep an ongoing top list of all participants/teams/events, and at the same time include a more contemporaneous or recent list to allow for fresh faces to receive recognition on a regular basis. This avoids the problem of some sites being dominated by the same persons and rendering the content somewhat stale. As seen in FIGS. 6A-6D, in addition to providing numerical scores for the ratings of the items, it may be desirable in some instances to collect additional data, such as aroma, flavor, color, etc. of the item in question. This can be used to construct the wine maps and correlations shown in FIG. 6E and FIG. 6F. In addition, it would be useful to create an easily useable, visible wine profile for the user to facilitate their review and selection of wine items. Preferably this is done through a touch-sensitive screen such as may be found on a portable computing device such as an iPhone and other similar devices.

For example a wine tasting/description tool known as a “wine wheel” is described at a website operated by UC Davis in California—www(dot)winearomawheel(dot)com incorporated by reference herein. This wheel includes a circle separated into distinct slices, which each portion noting a different flavor for a wine. The flavors are further distinguished as one approaches the edge of the circle, so that, for example, a “fruity” tasting wine can be further defined by a consumer as tasting like pear, apple, berries, etc. While tasting wheels have been in existence for several years (and in particular the aforementioned version has been in existence for almost two decades), and the benefit of these instruments is well-known, they have not been implemented to date in a form suitable for capturing electronic data as part of a small graphical user interface.

There is a long-felt need, therefore, for rendering this type taste descriptor into a tool more easily used by consumers. The captured data can be stored as a multi-dimensional descriptor vector of tags and scores for each item. Thus an item may have N different rating characteristics (including the descriptors noted herein) and M different rating values for each. For example, a wine may be rated on its “nuttiness” on a scale of 1-10, or on its “tannin” characteristics, or “fruitiness” or “aftertaste” and so on. The values may be simply binary indicating the existence of such characteristic (i.e., a wine has the flavor “pear” and so on). In a preferred approach the menu will be arranged in a hierarchy that presents only one level of categorization at a time, to avoid visual clutter, confusion and to not overwhelm the rater. Thus, only the top level of wheel may be presented in the screen, and only when the user selects an area/category will such field be expanded to show a second level. Again to improve playability and reduce barriers to data entry it is preferable that the number of descriptors be kept to some reasonable number suitable for the experience of the participant.

The final database of items 605 therefore includes both user ratings as well as item characteristic/descriptor tags and optional ratings. Preferably each participant, item, venue, rating and descriptor is associated with a unique ID, timestamp, etc. In some instances it may be desirable to pre-populate such descriptors and ratings within the database based on the contribution of experts, or crowd-sourced data from a social network site, etc. For example, the taste descriptor for a particular item may have certain characteristics already pre-populated or highlighted visually for the user to confirm or reject. Other forms and formats for capturing the data will be apparent from the present teachings. As ratings are collected from sampling events the database 605 can be updated as needed/desired.

Accordingly as shown in FIG. 6A, a ratings capture tool 610 within a graphical user interface 600 includes a polygon or circle 620 containing regions 625 associated with text descriptors 626 of the characteristics of an item. The polygon here is shown as an octagon but it will be understood that any reasonable shape that can accommodate the descriptors can be used. An additional field (or fields) 631 can be used for entering numerical data, such as a score attributed to the item 632 by the user (and all the other game parameters noted above), in the same manner and form as shown in FIG. 4C, namely through a physical or virtual keyboard 633. These fields may be incorporated on the same screen, or may be part of the same page such that the user must engage a scroll bar to access them (to avoid compressing the wine rating tool 610). In this fashion the text descriptors are displayed at different classification level levels with second level descriptors that are subclasses of first level descriptors.

As noted above, in some instances only certain characteristics may be highlighted already for the user to accept or reject. In some cases it may be desirable to capture the numeric ratings fields 631 and taste descriptor ratings of the wine rating tool 610 in separate screens as opposed to a single screen or page.

The interface 600 again is preferably included within a portable data collecting tool 630, such as an iPhone, a Palm Pre, or any other known device having a touch sensitive screen. These devices include firmware and other software adapted for detecting the presence and location of a human finger, a pointing device, etc., within the interface. Thus these algorithms and routines for implementing such touch-based icons can be implemented using any number of techniques known in the art.

As seen in FIG. 6D, at step 660 the various regions 625 are programmed to be associated with particular descriptors 626 which are appropriate for the item in question. For example, in a wine application the terms for describing the taste or aroma may be as shown in FIGS. 6A-6C. For other types of items the number of regions and descriptors will vary of course.

To describe an item, the user can simply tap or press their finger at step 665 within any portion of the polygon/circle 620 to specify one of the descriptors 626. The circle 620 may be programmed to be interactive, so that the regions 625 are highlighted as the user hovers over them, and/or after they are selected to help the user see what has already been identified. The user can specify one or more of the descriptors of the wine based on their subjective evaluation of the taste/aroma/color of the item.

As seen in FIG. 6B in some instances the ratings tool can be adapted to be dynamic so that as any one region 625 is selected, that section is magnified to reveal other smaller sub-regions 625′ each containing a more refined sub-descriptor 626′. As an example, a descriptor 625 labeled “fruity” may be associated with several sub-descriptors 626′ including: pear, apple, pineapple, etc. as shown. A rating magnitude or weight can be signified by repeating tapping (to increase a color intensity), or manual finger sizing of the descriptor.

As alluded to above, preferably the display and number of selections is limited to avoid confusing or overwhelming the user. The user can elect to further clarify his/her input in this manner if desired. Again the item taste/aroma/color input within tool 610 is useful but entirely optional and may be bypassed if desired by persons involved in a tasting event. All of the data captured can be used to update database 605, including a personal profile 606 for the user.

In other applications it may be desirable to combine the taste and numeric rating captures within a single tool 610. For example as seen in FIG. 6C the screen may provide visual feedback to the user in a field 690 indicating a score that varies in accordance with a distance of the users finger (or pointing device) from the center of the polygon/circle. This makes the task of capturing the data less cumbersome and easier on the user who only needs to engage a single interface to specify multiple pieces of rating data with a single input. The location within region 625 selected by the user can thus be considered as a two-dimensional capturing region where the X and Y coordinates specify different data values, such as a rating and an associated taste. The screen could be further modified so that as region 625′ is magnified, the user can specify both a rating and an intensity of the flavor using such coordinates as the taste attribute is implicitly defined. As an example of a similar type of technology used in a different application, see U.S. Pat. No. 6,313,833 incorporated by reference herein.

Returning to FIG. 6D, the taste data is then captured and stored in database 605 and profile 606 at step 670, where it can be combined with the numeric rating data to form or supplement an existing multi-dimensional vector characterizing the item. Thus, an item description vector may include multiple rating/evaluation fields {R1, R2, . . . Rn} where R1, R2 are numeric attributes and taste or other similar attributes. The collection of this type of data allows for greater range of data mining, comparisons and evaluations of suitable recommendations for users, since they can now be compared on multiple dimensions other than pure numeric ratings alone on a single parameter.

As an example in a wine rating application the user's (U1) rating for wine X can be evaluated at step 680 to determine other appropriate recommendations based on the fact that they rated a particular wine with a high score (R1) and further remarked that the wine had a particular attribute (R2). Based on this observation the system can develop additional correlations to other wines (W1, W2, W3 . . . Wn) having attribute R2, even if U1 has not tasted the item, and even if the items are not yet rated by other users (U2, U3 . . . Um) correlated to U1. In other instances more precise and accurate recommendations can be presented to users based on combining and assessing both ratings and attributes to derive more accurate taste profiles. Accordingly a prediction and a recommendation for an item and a user can be generated at step 680 based on multiple attributes, including both an explicit rating for an item, and other secondary data such as one or more detected tastes, aromas or other characteristics for the item.

The user's taste profile can be derived from a database of items 605 in the same way, even in the absence of explicit characteristics provided by the participant. At step 685 the user's ratings for the items are analyzed to determine an optimal and reduced feature set that best correlates the user's rating to a particular item. In other words, the user's ratings and the wine features are processed to determine the dimensions or characteristics most important to that particular participant. As an example, it may be determined that the user's rating score is highly correlated positively to a “fruit” score, and correlated negatively with a “tannin” score. Any number of known techniques may be used to perform this taste characterization analysis.

Based on this analysis, a customized or personalized wine profile is generated at step 688 and presented to the user in graphical form, such as shown by wine mapper 690 in FIG. 6E. A matching symbol 691 is also associated to the user to make it easier for them to identify items of interest. The intent of this tool 690 is to assist users in assessing and identifying suitability of new wine items.

As such the wine mapper 690 is laid out with a form designed to present the user's primary optimized wine features, and appropriately scaled in accordance with a determined correlation. Thus, if it is determined that the user's ratings are correlated with 5 primary characteristics, each primary characteristic is further weighted visually by size, color or intensity in the wine mapper 690. In the example shown, the user's main distinguishing characteristic is the degree of crispness of the wine; therefore, compared to other characteristics it is scaled to be larger. Each characteristic can be scaled this way to complete a wine canvas 692. The canvas further includes fill data 693, identifying the participant's preferred characteristic, a weighting/rating for the attribute or feature in question, etc. This can again be based on identifying their own proffered characteristic rating, or matching it to existing values presented in database 605. It will be appreciated that the identity of the wine mapper 690 characteristics can be further refined to take into consideration of the type of wine being rated, so that different characteristics are presented for say a Chardonnay vs. a Cabernet, as the two have very different compositions and elicit different tags and ratings for particular characteristics.

The user is further presented with a matching profile symbol 691 in the interface, again based on matching the user to one of N standardized taste profiles derived from the user and item databases. The symbols can be used for quick, short hand visual cues and clues to a user on items of interest. The logical hierarchy of the symbols is configured to match or overlay an existing logical grouping or ontology of articles or objects. Thus, a user with an eagle symbol is most related in profile/taste to other users with eagle symbols, and somewhat less so to other users with bird symbols. That same eagle user would still have some overlapping tastes with other animals, but less so with a terrestrial animal (i.e., a bull, dog or lion) and even less so with an aquatic animal (dolphin). The use of inverted letters is also described above and can be similarly exploited to assist in rapid mental decoding of appropriate items for a user. Other examples will be apparent to those skilled in the art, and it is expected that the profiles can be used in other domains to assist users in selecting goods and services.

The wine mapping tool 690 can be used as seen in FIG. 6F to identify a degree of correlation to a new wine discovered or identified by the user, or another user. For example the use may be shopping, and see a new item on the shelf they have not seen before. The user can input SKU data for the wine, or an image of the wine label, and have it identified within database 605. Alternatively the user may be interested to see how their profile matches to another user.

A wine profile routine (running on the user's phone, or on a remote server) can then retrieve the relevant characteristic data for the new wine/comparative user, and overlay it as shown to help the user understand and assess the degree of congruence with such item or other user. As seen in this representation, an overall congruence of features and associated ratings are visually presented as a shape 694 which makes it easy for users to assess new items and their potential interest to them. The relationship of the shape between areas 694 (the item features) and area 693 (the user's taste features) is a visual clue to the item's potential desirability. The more the shape appears to be circular, the more likely it will be appealing to the user. Similarly, the degree and extent of overlap of area 694 to area 693 further acts as a visual depiction of the correlation of the new item (or user) to the user. As alluded to earlier, the tool can present an overlap to different characteristics depending on the specific varietal (Sauvignon Blanc vs. Chardonnay) or even as simple as white/red/rose, etc.

In addition, an overall correlation score 696 can be presented to help the user make the assessment. In addition, a predicted rating score 697 is also given to assist the user in assessing the potential purchase. Other relevant data can be presented as well in a portion of the interface 698 accordance with a desired information requirement, including ratings for the item collected from recent sampling events, from friends of the user in a social network, close friends in a particular group, etc.

In some embodiments the user can do a query in a query interface portion 699 against a database of profiles of other users to find individuals with similar tastes, meaning with similar primary features and feature weightings. This query can be done based on the user's wine profile 692 or based on other parametric data such as described above. By locating other individuals and seeing their preferred tastings, users can again identify new items easier and faster than before. The results, including best matching items, users, and scores can also be presented in any desired format.

As seen in FIG. 6F, the overlay of the data makes it faster, more enjoyable and aesthetically satisfying than simply being presented with a single number, or a series of numbers. The user can “see” precisely how the unknown item maps to their existing tastes very rapidly and with better understanding.

It will be understood that other characteristics would be used to identify other items of course, and the present teachings can be employed in other product domains, including other food types, or any other product which can be described by rated dimensions, and then scaled and overlaid as shown. While the mapper is shown in the form of a circle or pie with different shaped wedges, other visual forms which permit rapid and accurate assessment can be employed as well.

As noted earlier, an additional parametric selector tool 699 can be presented to the user as well to assist them in finding other wines that meet particular criteria and dimensions of interest to them. The parametric selections are converted into query form so that relevant entries can be retrieved from database 605 for the user, matching their desired selection. For example a user could request a list of wines that equal or exceed certain slider values for fruitiness, tannin, aftertaste, etc. Other examples will be apparent to persons skilled in the art.

Another application of the game/sampling event results is that a conventional CAPTCHA system can use the items and participant ratings as challenge questions. For example, an online test could ask a user to identify, from a series of items (e.g., wines) which one they had recently sampled. In addition they could be asked to identify whether they liked the wine or not as a secondary question. Alternatively a user could be prompted to identify a taste symbol for a social network friend (i.e., whether they are a bull, a crow, etc.) that is part of a set of challenge items. Similar questions could be asked to exploit the data captured during the game so that a CAPTCHA or security question can be constructed based on historical data known to the user but not to others. Since a brand associated with the item may want to continue re-targeting the user, this technique has a twofold benefit or purpose.

It will be apparent to those skilled in the art that the present invention, including those aspects illustrated in FIGS. 1-6 can be implemented using any one of many known programming languages suitable for creating applications that can run on large scale computing systems, including servers connected to a network (such as the Internet). The details of the specific implementation of the present invention will vary depending on the programming language(s) used to embody the above principles, and are not material to an understanding of the present invention. Furthermore it will be apparent to those skilled in the art that this is not the entire set of software modules that can be used, or an exhaustive list of all operations executed by such modules. It is expected, in fact, that other features will be added by system operators in accordance with customer preferences and/or system performance requirements. Furthermore, while not explicitly shown or described herein, the details of the various software routines, executable code, etc., required to effectuate the functionality discussed above in such modules are not material to the present invention, and may be implemented in any number of ways known to those skilled in the art.

The above descriptions are intended as merely illustrative embodiments of the proposed inventions. It is understood that the protection afforded the present invention also comprehends and extends to embodiments different from those above, but which fall within the scope of the present claims.

What is claimed is:

1. A method of conducting a sampling event for items with a computing system comprising:
(a) providing a set of items;
(b) providing a first routine for capturing input data from a group of participants within an interactive graphical interface; said input data including:
1) numerical ratings for said set of items;
2) text descriptors for said items presented in a hierarchical menu;
(c) capturing said text descriptors by displaying a first classification level with first descriptors, and in response to a selection of one of said first descriptors displaying a second classification level with second descriptors that are subclasses of said first descriptors;
wherein a participant can select one or more of said first descriptors and/or said second descriptors;
(d) capturing weighting information for said text descriptors that is based on a finger and/or pointing device position detected for said participant in said hierarchical menu.

2. The method of claim 1, including a step: processing said ratings information and text descriptors to generate a taste profile for said participant.

3. The method of claim 2, wherein a symbol is associated with the participant and presented as a mnemonic representing said taste profile.

4. The method of claim 3, wherein said symbol is a graphical image representing one or more of an animal, a rotated text character, and a distorted text character, and an object.

5. The method of claim 1, further including a second game wizard routine configured to present an avatar that generates a prediction of participant ratings data and simulates ratings results for the set of items in the sampling event including prior to such event.

6. The method of claim 5, wherein said second game wizard routine is configured to measure and present a performance of said avatar in said prediction of participant ratings data.

7. The method of claim 5, wherein said second game wizard routine calculates both individual and group predictions.

8. The method of claim 7, wherein said second game wizard routine further presents suggestions to a sample event host for alterations of said set of items and/or said participants.

9. The method of claim 8, wherein said alterations are determined based on a desired target sampling event score to be achieved at a future sampling event.

10. The method of claim 5, wherein said second game wizard routine further calculates one or more diversity score(s) for a scheduled sampling event, which diversity score(s) identifies a value representing differences in ratings predicted for said participants.

11. The method of claim 1, further including a second sampling event search routine configured to allow would-be participants to find and select upcoming sampling events based on a sampling event query.

12. The method of claim 11, wherein said sampling event query can specify one or more of: a discount coupon; one or more participants; a venue; a sampling item; predicted participant ratings; a predicted diversity score.

13. The method of claim 1, wherein said first routine is further configured to capture prediction data from the participants matching sampled unknown items to one or more identified items.

14. The method of claim 1, wherein said first routine is further configured to capture timestamp data for ratings made by the participants during the sampling event.

15. The method of claim 1, wherein said first routine is further configured to capture prediction data from the participants matching prices to sampled unknown items.

16. The method of claim 1, wherein said first routine is further configured to capture prediction data from a participant specifying if an unknown item being sampled is associated with the participant.

17. The method of claim 1, further including a second trend routine configured to present a value of a rating trend measured for the participants during the sampling event.

18. An electronic interactive planning assistance tool for a social game comprising:
one or more game wizard routines adapted to execute on a computing system and to perform at least the following operations:
(a) process an initial proposed set of sample items for the social game;
(b) process an initial proposed set of participants for the social game;
(c) simulate an outcome of the social game by predicting ratings likely to be made by said set of participants for said set of sample items.

19. The electronic interactive planning assistance tool of claim 18, wherein said game wizard routine(s) perform(s) said simulation at step (c) based on participant ratings data and item ratings data from prior social games stored in a database.

20. The electronic interactive planning assistance tool of claim 18, wherein said participant ratings data and item ratings data includes multidimensional ratings data.

21. The electronic interactive planning assistance tool of claim 18, wherein a confidence score is presented for said game wizard routine(s) simulation outcome.

22. The electronic interactive planning assistance tool of claim 18, wherein said game wizard routine(s) are adapted further to calculate and present a ratings score diversity for the set of participants.

23. The electronic interactive planning assistance tool of claim 18, wherein said game wizard routine(s) are adapted further to interact with participants during the social game.

24. The electronic interactive planning assistance tool of claim 23, wherein said game wizard routine(s) communicate approval or disapproval of a participant's rating.

25. The electronic interactive planning assistance tool of claim 18, wherein said game wizard routine(s) are adapted further to dynamically alter said predicted ratings in response to actual ratings presented during the social game.

26. The electronic interactive planning assistance tool of claim 18, wherein said game wizard routine(s) are adapted further to optimize one or more social game characteristic scores by automatically altering said initial proposed set of sample items and/or said initial proposed set of participants.

27. The electronic interactive planning assistance tool of claim 18, wherein said game wizard routine(s) are adapted further to calculate and present social game characteristic scores based on a social game host data input altering said initial proposed set of sample items and/or said initial proposed set of participants.

28. The electronic interactive planning assistance tool of claim 27, wherein said game wizard routine(s) are adapted further to present suggestions to said social game host for said set of sample items and/or said set of participants.
